(19) United States
(12) Patent Application Publication
(10) Pub. No.: US 2026/0319765 A1
(43) Pub. Date: Oct. 15, 2026

(54) METHOD FOR GENERATING INTERACTIVE DIGITAL REPRESENTATIONS USING PSYCHOMETRIC ELEMENTS AND ARTIFICIAL INTELLIGENCE MODELS

(71) Applicant: PRAXIS AI, LLC, Sacramento, CA (US)

(72) Inventors: David James Clarke, IV, Pleasanton, CA (US); Hugues A. Lebegue, Livermore, CA (US)

(21) Appl. No.: 19/647,154

(22) Filed: Apr. 14, 2026

Related U.S. Application Data
(60) Provisional application No. 63/788,645, filed on Apr. 14, 2025.

(51) Int. Cl. G06F 8/35; G06N 5/01; G06N 5/02

(52) U.S. Cl. CPC G06F 8/35; G06N 5/01; G06N 5/02

(57) ABSTRACT

The disclosure provides a method for generating interactive digital representations of entities using artificial intelligence. The method involves collecting psychometric elements of an entity and generating model training instructions based on these elements. An artificial intelligence model is then trained using these instructions to form a trained model. Digital content representative of the entity is collected and processed to develop accessible content readable by the trained model. Finally, software code is generated that, when executed, initiates an interactive digital representation of the entity, utilizing the trained model and the accessible content to facilitate dynamic interactions.

### RELATED APPLICATIONS

This application claims the benefit of U.S. Provisional Application No. 63/788,645, filed Apr. 14, 2025, the entire contents of which are incorporated herein by reference.

### TECHNICAL FIELD

The disclosed subject matter relates generally to artificial intelligence systems and computer-implemented digital agent technologies, and more particularly to techniques for generating and operating interactive digital representations of entities using psychometric data, machine-learning models, and secure digital content integration.

### BACKGROUND OF THE INVENTION

The current field of artificial intelligence and interactive agent technologies has increasingly turned to approaches designed to create digital representations of entities, including professionals, experts, educators, organizations, brands, and other knowledge sources, that can interact with users in a manner reflecting the represented entity's expertise and communication characteristics. These systems are often built on complex models that attempt to process and deliver content in a manner that is both informative and responsive.

Many existing systems designed to support expertise interactions through digital means struggle with achieving a consistently personalized experience. Frequently, techniques based on generic, template-driven responses or overly simplified computational models fail to reflect the depth and nuance of a human expert's experiential approach. Such systems may deliver information accurately, but they often lack the coherent personality calibration necessary for a truly engaging encounter. This inconsistency can lead to digital interactions that appear disjointed and fail to fully resonate with users, diminishing the overall effectiveness of these technologies in a knowledge-transfer context.

More specifically, challenges arise when integrating multiple information sources with advanced language processing models within secure frameworks. Digital platforms often face the dilemma of balancing the need for robust protection of sensitive or proprietary content with the requirement to provide personalized and contextually relevant support and guidance. When disparate data sources are brought together, ensuring that the output maintains a unified and authentic representation of an expert's communication style becomes particularly problematic.

### SUMMARY OF THE INVENTION

In one example, a computer-implemented method, system, and non-transitory computer-readable medium are provided for generating, configuring, deploying, and operating an interactive digital representation of an entity. The entity may be an individual, organization, professional, educator, expert, brand, team, or other source associated with a body of knowledge, communication characteristics, or behavioral patterns. One or more psychometric elements associated with the entity may be obtained from structured assessments, interviews, observed communications, authored materials, historical interactions, behavioral data, and other entity-related information sources. The psychometric elements may include, by way of example, personality traits, communication preferences, instructional style, response tendencies, tone, vocabulary usage, decision patterns, domain emphasis, and interaction objectives. Based at least in part on the psychometric elements, one or more model instructions, configuration parameters, prompts, fine-tuning inputs, adapter settings, behavioral constraints, or other control data may be generated to train, adapt, steer, or otherwise configure one or more artificial intelligence models so that outputs produced by the resulting system more closely reflect selected characteristics of the entity.

In one example, digital content representative of the entity may be collected from one or more content sources and transformed into machine-accessible content for use by the interactive digital representation. The digital content may include, by way of example, transcripts, written publications, presentations, educational materials, recorded media, interviews, notes, policies, correspondence, historical chat sessions, structured databases, enterprise documents, website content, frequently asked questions, curated knowledge assets, and other materials associated with the entity or a domain represented by the entity. The digital content may be normalized, segmented, annotated, enriched with metadata, classified, filtered, summarized, embedded, indexed, or otherwise processed to form accessible content readable by the one or more artificial intelligence models. In one example, software code, executable workflows, hosted services, application components, or interface components may be generated, assembled, or deployed to initiate the interactive digital representation and make the interactive digital representation available through one or more user-facing channels.

In another example, the accessible content may be managed within a secure knowledge architecture configured to control ingestion, storage, retrieval, sharing, and presentation of entity-related information. The secure knowledge architecture may include one or more protected repositories, partitioned data stores, access-control layers, token-level restrictions, trust-tier classifications, provenance-aware validation mechanisms, anonymization operations, redaction operations, policy enforcement engines, and audit capabilities. In one example, different categories of users, systems, organizations, or interaction contexts may be granted different levels of access to underlying content, intermediate representations, summaries, or generated outputs. In another example, the system may preserve distinctions among private content, organizational content, public content, inferred content, and user-contributed content so that the interactive digital representation can respond using content authorized for a particular request while preventing disclosure of unauthorized information.

In one example, the accessible content may be represented using multiple complementary knowledge structures. For instance, portions of the content may be converted into vector embeddings for semantic similarity retrieval, while other portions may be arranged in a tree-based knowledge structure, graph-based knowledge structure, relational structure, or hybrid structure to preserve hierarchy, associations, and contextual dependencies. In another example, entity-specific content may be linked to topics, subtopics, concepts, sources, permissions, confidence indicators, freshness indicators, and relationship edges so that the system can retrieve not only semantically similar passages but also structurally related information. Such arrangements may enable the interactive digital representation to access current and historical information, support contextual grounding, maintain response traceability, and improve consistency across multiple sessions and use cases.

In one example, retrieval of content for response generation may be performed through multiple retrieval pathways. A request received from a user may be analyzed to identify intent, subject matter, access rights, interaction history, and one or more candidate retrieval strategies. The system may then perform vector-based retrieval, graph-based retrieval, keyword-based retrieval, metadata-based retrieval, rule-based retrieval, source-restricted retrieval, permission-constrained retrieval, temporal retrieval, or combinations thereof. Results from different retrieval pathways may be merged, ranked, reranked, filtered, deduplicated, scored for trustworthiness, and assembled into a context package used by the one or more artificial intelligence models. In another example, the system may weigh retrieved information differently based on source reliability, relationship to the entity, recency, user role, historical effectiveness, or alignment with the psychometric elements of the entity.

In one example, the interactive digital representation may operate using a plurality of artificial intelligence models rather than a single model. Different models may be used for different functions, including natural-language understanding, response generation, summarization, retrieval planning, entity-style alignment, tool selection, speech processing, or structured output generation. In another example, the system may selectively switch among models or allocate different portions of a workflow to different models based on criteria such as prompt complexity, latency objectives, content sensitivity, computational cost, domain specialization, output format, or quality metrics. The system may also apply model-specific prompts, adapters, safety controls, context-construction routines, or evaluation layers so that multiple models can cooperate in generating a coherent response while preserving selected characteristics of the entity.

In one example, the interactive digital representation may further support tool invocation and external system integration. The system may determine that a user request is better served by invoking one or more tools, agents, application programming interfaces, databases, scheduling systems, communication services, analytics modules, enterprise platforms, or transactional systems. The one or more artificial intelligence models may generate structured requests for such tools, receive returned data, and incorporate the returned data into a grounded response. In another example, tool access may be conditioned on permissions associated with a user, organization, content source, or trust level. In this manner, the interactive digital representation may perform not only conversational response generation but also agentic task execution, guided workflows, information retrieval from live systems, and coordinated action across multiple services.

In one example, the interactive digital representation may be deployable across multiple interaction surfaces, including text interfaces, chat environments, web interfaces, mobile interfaces, voice interfaces, meeting assistants, messaging platforms, customer-service channels, educational platforms, enterprise dashboards, and application-embedded experiences. In another example, the same underlying entity representation may be rendered differently depending on the interaction surface, user type, jurisdiction, organizational context, content availability, or communication objective. Voice-based examples may include speech-to-text processing for incoming utterances, text-to-speech rendering for generated responses, turn-taking management, interruption handling, and conversational pacing controls that preserve the selected style or persona of the entity.

In one example, the system may maintain conversational continuity across sessions, devices, and interaction channels. Conversation history may be captured, segmented, summarized, indexed, and selectively retained to preserve useful context while reducing token consumption. In another example, when accumulated conversation content approaches a threshold associated with model context limitations, the system may generate one or more compressed representations, summary memories, state objects, or context abstractions representing earlier exchanges while preserving more recent exchanges in greater fidelity. The compressed representations may be stored and later reintroduced into a subsequent interaction to enable continuity without requiring full replay of all prior content. In this manner, the system may support persistent interactions that extend beyond an individual model context window while maintaining responsiveness and contextual relevance.

In one example, response generation and delivery may include streaming and incremental rendering operations. Generated output may be partitioned into portions designated as finalized, stable, provisional, or modifiable so that a client device or interface can render content efficiently while allowing later refinement of selected regions. In another example, the system may cache stable response portions, revise only designated modifiable portions, and coordinate streamed delivery with retrieval updates, tool results, or additional grounding information received during generation. Such arrangements may improve interface responsiveness, reduce redundant computation, and support dynamic response construction in environments where data availability changes during an active session.

In one example, the disclosed techniques may improve the ability to create and operate a digital representation that reflects selected characteristics of an entity while grounding outputs in authorized information associated with that entity. The disclosed techniques may further improve personalization, knowledge security, retrieval quality, context preservation, interoperability, scalable deployment, and continuity of interaction across different channels and computational environments. In another example, the disclosed techniques may enable a digital representation to provide responses, guidance, instruction, analysis, or task assistance in a manner that is both behaviorally aligned with the represented entity and constrained by controlled access to relevant underlying content.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating an example system environment for generating and operating an interactive digital representation of an entity using psychometric inputs, entity-related digital content, and one or more artificial intelligence models, in accordance with one or more techniques of this disclosure.

FIG. 2 is a block diagram illustrating a more detailed example of a computing device configured to perform the techniques described herein.

FIG. 3 is a diagram illustrating an example multi-modal interaction architecture through which the interactive digital representation communicates with users via text, voice, and visual interface channels, in accordance with one or more techniques of this disclosure.

FIG. 4 is a flow diagram illustrating an example process for collecting psychometric elements associated with an entity and generating model training instructions for configuring one or more artificial intelligence models, in accordance with one or more techniques of this disclosure.

FIG. 5 is a flow diagram illustrating an example end-to-end process for creating, deploying, and operating an interactive digital representation using psychometric data and processed digital content representative of the entity, in accordance with one or more techniques of this disclosure.

FIG. 6 is a block diagram illustrating an example provider-agnostic orchestration architecture for routing requests among multiple artificial intelligence model providers and model types, in accordance with one or more techniques of this disclosure.

FIG. 7 is a flow diagram illustrating an example dynamic tool registration and invocation process for discovering, authorizing, translating, and invoking externally provided tools, in accordance with one or more techniques of this disclosure.

FIG. 8 is a diagram illustrating an example Tree of Knowledge architecture in which digital content is organized across multiple tiers associated with different trust levels and sharing scopes, in accordance with one or more techniques of this disclosure.

FIG. 9 is a flow diagram illustrating an example intellectual property vault pipeline for ingesting protected content, applying security controls, and selectively releasing authorized content for retrieval and generation, in accordance with one or more techniques of this disclosure.

FIG. 10 is a flow diagram illustrating an example retrieval pipeline that uses the Tree of Knowledge and the intellectual property vault to identify, authorize, rank, and assemble content for response generation, in accordance with one or more techniques of this disclosure.

FIG. 11 is a block diagram illustrating an example event-driven communication bus architecture for coordinating session management, retrieval, prompt construction, model dispatch, tool execution, and response streaming, in accordance with one or more techniques of this disclosure.

FIG. 12 is a diagram illustrating an example knowledge graph augmented retrieval architecture that combines semantic retrieval, graph-based retrieval, and ranking operations to provide structured memory for the interactive digital representation, in accordance with one or more techniques of this disclosure.

FIG. 13 is a flow diagram illustrating an example conversation history compaction and persistent caching process for preserving continuity across interaction sessions while reducing context usage, in accordance with one or more techniques of this disclosure.

FIG. 14 is a flow diagram illustrating an example streamed response rendering process in which output is partitioned into stable and modifiable regions for incremental presentation and caching, in accordance with one or more techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

Conventional artificial intelligence systems that provide conversational assistance or subject-matter guidance often generate responses based on generalized language patterns without adequately capturing the personality, communication style, teaching methodology, or other psychometric characteristics of a particular entity. As a result, such systems may produce interactions that are inconsistent with the entity being represented, may fail to maintain a coherent behavioral profile across sessions or tasks, and may provide responses that do not sufficiently reflect institution-specific or entity-specific source materials. Additional technical challenges arise when digital content associated with the entity includes sensitive or proprietary information, because increasing accessibility of such content for model use can conflict with security, privacy, and access-control requirements. Further challenges can arise from reliance on a single model, fragmented retrieval pipelines, and limited context windows, each of which can reduce response quality, hinder continuity across interactions, and constrain deployment across different interfaces and operational workflows.

The disclosed techniques address these issues by generating model training instructions derived at least in part from psychometric elements of the entity, training or configuring an artificial intelligence model using the model training instructions, and combining the trained model with accessible content developed from digital content representative of the entity to produce an interactive digital representation. The accessible content may be organized and protected using an IP Vault and a hierarchical Tree of Knowledge that enforce entitlement-aware access control, provenance-based verification, controlled transformations such as anonymization and redaction, and tiered trust boundaries. Response generation may be improved through parallel retrieval pathways, structured knowledge representations, rank fusion and reranking, and controlled context construction. The system may also maintain continuity across extended interactions through conversation compaction and persistent caching, and may support operation across multiple models, tools, and interaction interfaces while preserving behavioral consistency and controlled disclosure of underlying knowledge resources.

The disclosed technology provides a computer-implemented architecture for generating and operating an interactive digital representation of an entity using psychometric personalization and entity-specific knowledge grounding. Psychometric elements associated with the entity are obtained and used to generate model training instructions that train or configure one or more artificial intelligence models so that generated outputs conform to selected behavioral and communication characteristics of the entity. Digital content representative of the entity is collected and processed into accessible content that is readable by the trained model, enabling response generation that is both style-aligned and grounded in entity-related information.

A secure knowledge framework protects and organizes the accessible content. An IP Vault compartmentalizes protected content and enforces provenance-aware, entitlement-based release of content for retrieval and generation. A Tree of Knowledge organizes accessible content across multiple trust and sharing tiers so that retrieval may prioritize authorized, contextually proximate materials while preserving controlled sharing across organizational boundaries. Multiple retrieval pathways, including vector-based retrieval and structured retrieval using a knowledge graph, may be used together with rank fusion and reranking to improve relevance and consistency.

The architecture supports operational flexibility through orchestration of model selection, prompt construction, tool invocation, and response streaming. Multiple models may be supported, including routing and switching based on request characteristics while maintaining behavioral consistency through shared training instructions and configuration data. The system supports extended interactions through conversation compaction and persistent caching, and may further support agentic task execution and controlled integration with external systems through entitlement-aware tool use.

The disclosed subject matter is implemented through a particular computing architecture that changes how a computing system generates and operates an interactive digital representation using psychometric data and entity-related digital content. The system performs machine-executed operations including collecting psychometric elements, generating model training instructions from the psychometric elements, training or configuring an artificial intelligence model using the model training instructions, transforming digital content into accessible content structured for retrieval, and initiating operation of the interactive digital representation using the trained model and accessible content. These operations create and use machine-readable control data and machine-readable content representations that alter subsequent operation of the computing system during response generation.

The disclosed techniques improve operation of a computing system by transforming heterogeneous source content into secured and retrieval-ready forms specifically structured for machine use. The system transforms content into vector embeddings, associates provenance metadata with content units, applies fine-grained access control including token-level release constraints, and organizes content in a hierarchical knowledge structure with controlled promotion across trust tiers. The IP Vault enforces entitlement-aware release rules and supports controlled transformations such as anonymization, redaction, and summarization. These operations improve storage security and retrieval behavior for retrieval-augmented generation systems by enabling differentiated access and reducing indiscriminate exposure of protected materials.

The disclosed techniques also address technical constraints of model context limits, heterogeneous model capabilities, and real-time streaming. The system monitors accumulation of conversation content and generates compacted representations for reuse in subsequent prompts to conserve context capacity while preserving continuity. The system may select among multiple models based on request characteristics, coordinate multiple retrieval pathways, fuse and rerank retrieved results, and partition streamed output into stable and modifiable regions to reduce repeated rendering and repeated processing. These features improve computer functionality by reducing redundant computation, improving retrieval quality, enabling cross-session continuity, and coordinating technical subsystems during interactive operation.

Integrations with external tools and systems are performed through authenticated interfaces and structured tool requests, with entitlement controls limiting what content may be provided as tool inputs and what tool outputs may be incorporated into a response. The resulting system is integrated into a practical technical environment that includes protected repositories, retrieval structures, authorization frameworks, event-driven orchestration, and streaming pipelines. The disclosed subject matter is therefore directed to improvements in computer functionality, including improved protection and controlled use of digital content, improved retrieval and context construction, improved resource management for model limitations, and improved coordination of components used to generate interactive outputs.

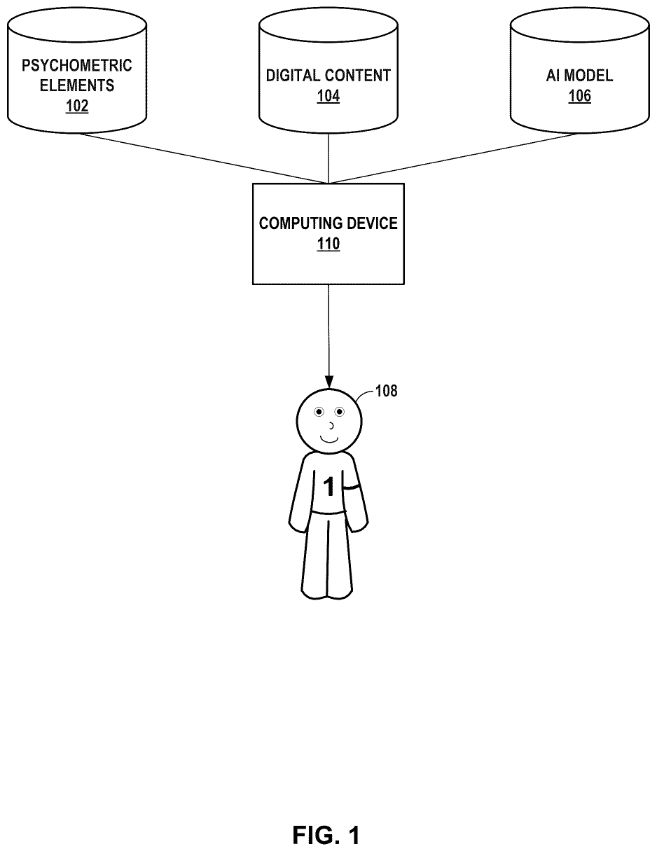

FIG. 1 is a block diagram illustrating an example system environment for generating and operating an interactive digital representation of an entity using psychometric inputs, entity-related digital content, and one or more artificial intelligence models, in accordance with one or more techniques of this disclosure.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smart home component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in FIG. 1, the system includes one or more psychometric elements 102, digital content 104, an artificial intelligence model 106, a computing device 110, and an interactive digital representation 108. In the illustrated embodiment, computing device 110 is communicatively associated with psychometric elements 102, digital content 104, and artificial intelligence model 106, and computing device 110 generates or otherwise initiates interactive digital representation 108 based at least in part on psychometric elements 102, digital content 104, and artificial intelligence model 106. FIG. 1 may represent a general representation of the disclosed techniques.

Psychometric elements 102 may comprise one or more psychometric elements of the entity. For example, psychometric elements 102 may comprise one or more of personality traits, communication style, instructional or advisory methodologies, answers to a personality questionnaire, results of a personality test, behavioral assessments, expert interviews, content analysis, and experience of the entity. In accordance with the techniques described herein, computing device 110 may collect psychometric elements 102 and may generate a set of one or more model training instructions based at least in part on psychometric elements 102. In some examples, the set of one or more model training instructions may be structured as a multi-section behavioral specification document defining one or more of mission and values, helpfulness standards, role hierarchy, transparency requirements, and safety boundaries, combined with institution-level and user-level contextual data to govern behavior of interactive digital representation 108.

Digital content 104 may comprise digital content representative of the entity. In some examples, digital content 104 may comprise one or more of content authored by the entity, content output of the interactive digital representation of the entity, content descriptive of the entity, an interview with the entity, video content including the entity, text about the entity, images of the entity, audio spoken by the entity, audio spoken about the entity, and other content from which relevant information can be extracted that enhances the interactive digital representation's ability to simulate the entity's communication style and expertise. Computing device 110 may collect digital content 104 and may process digital content 104 to develop accessible content readable by a trained artificial intelligence model. In some examples, processing digital content 104 may comprise accessing elements from an IP Vault for secure knowledge compartmentalization, implementing added security measures through token-level encryption, and utilizing a Tree of Knowledge architecture to organize and prioritize information based on hierarchical trust levels.

Artificial intelligence model 106 may comprise the artificial intelligence model trained by computing device 110 using the set of one or more model training instructions. In some examples, computing device 110 may train artificial intelligence model 106 using the set of one or more model training instructions to form a trained artificial intelligence model. In some further examples, artificial intelligence model 106 may comprise a first large language model of a plurality of large language models, and computing device 110 may switch among the plurality of large language models based at least in part on user input or characteristics of content of a prompt. The trained artificial intelligence model may utilize the accessible content developed from digital content 104 to generate output consistent with the entity.

Computing device 110 may include one or more processors configured to coordinate collection of psychometric elements 102, collection and processing of digital content 104, training and utilization of artificial intelligence model 106, and generation of software code that, when executed, initiates interactive digital representation 108. In some examples, computing device 110 may route interaction events through a central communication bus coordinating AI model dispatch, knowledge retrieval, tool invocation, and response streaming through an event-driven dispatch pattern enabling independent scaling of subsystems. Computing device 110 may further maintain a role-based entitlement framework that manages access to resources and functionalities, a tool integration framework that enables the digital representation to interact with external applications and services, and a pattern recognition algorithm that analyzes user interactions to identify user preferences and knowledge gaps.

Interactive digital representation 108 may comprise a representation of the entity generated by computing device 110 using the trained artificial intelligence model and the accessible content. In the illustrated embodiment, interactive digital representation 108 is shown as a user-facing representation produced below computing device 110, indicating that computing device 110 may output or instantiate interactive digital representation 108 for interaction with a user across one or more interaction surfaces. In some examples, interactive digital representation 108 may employ a conversational voice interface supporting a plurality of real-time speech interaction protocols. In some further examples, interactive digital representation 108 may be used to perform an agentic task and generate output as a result of performing the agentic task while maintaining fidelity to psychometric elements 102 of the entity.

Accordingly, FIG. 1 illustrates an example arrangement in which computing device 110 receives or accesses psychometric elements 102, digital content 104, and artificial intelligence model 106 and, based on such inputs, generates software code that initiates interactive digital representation 108. Although illustrated with the particular components shown in FIG. 1, the system may include additional components, fewer components, or alternative arrangements of the illustrated components while remaining within the scope of this disclosure.

In accordance with the techniques of this disclosure, computing device 110 may collect one or more psychometric elements of an entity. Computing device 110 may generate a set of one or more model training instructions based at least in part on the one or more psychometric elements. Computing device 110 may train an artificial intelligence model using the set of one or more model training instructions to form a trained artificial intelligence model. Computing device 110 may collect digital content representative of the entity. Computing device 110 may process the digital content to develop accessible content readable by the trained artificial intelligence model. Computing device 110 may generate software code that, when executed, initiates an interactive digital representation of the entity, wherein the interactive digital representation utilizes the trained artificial intelligence model and the accessible content.

Existing systems designed to create interactive digital representations of entities face challenges in maintaining consistent behavioral characteristics, integrating multiple information sources with advanced language models within secure frameworks, and balancing accessibility of content with protection of proprietary knowledge.

In the rapidly evolving landscape of educational technology, institutions face significant challenges in effectively integrating artificial intelligence (AI) systems to enhance learning experiences while safeguarding proprietary content. Traditional educational AI systems often struggle to maintain consistent personality traits across interactions, leading to disjointed user experiences and diminished educational effectiveness. Furthermore, these systems typically rely on template-based responses, achieving only limited personalization and failing to authentically replicate human expertise. The technical limitations of existing AI platforms, including single-model dependencies and inadequate security measures, exacerbate these issues, creating barriers to effective AI integration in educational contexts.

AI systems developed in earlier works primarily focus on generic question-answering capabilities without maintaining consistent expertise methodologies or personality traits. These systems often employ basic relevance metrics for information retrieval, resulting in responses that do not appropriately prioritize institutional knowledge. Additionally, current solutions encounter significant technical barriers to integration with learning management systems (LMS), often necessitating custom development or substantial modifications that increase implementation costs and complexity. The absence of cohesive personality integration and consistent expertise methodologies in multi-agent systems further limits their effectiveness, requiring considerable human oversight and manual configuration for specific functions.

The present system addresses these challenges by introducing a technical approach that transforms entity-specific expertise into structured, interactive digital representations through an advanced Neural Engine architecture that coordinates multiple AI models, secure knowledge repositories, and external tools while preserving behavioral consistency. This approach transforms unstructured human expertise into structured, interactive digital representations that provide personalized educational experiences. The Neural Engine serves as a specialized communication bus between multiple AI components, enabling seamless integration with proprietary knowledge repositories while maintaining personality consistency. By implementing a vector-based personality mapping system, the approach achieves high accuracy in replicating human expertise, instructional or advisory methodologies, and personality traits. The system's secure knowledge compartmentalization and dynamic source prioritization ensure that digital twins provide information aligned with institutional standards, enhancing the overall experience.

The techniques of this disclosure include a method for creating an interactive digital representation of an entity by leveraging psychometric elements and digital content. This method involves several steps, including collecting psychometric data, generating model training instructions, training an AI model, processing digital content, and generating software code for the digital representation.

The operational principle of this method involves the integration of psychometric data with digital content to create a personalized and interactive digital representation. This approach combines psychological profiling with AI model training, allowing the digital representation to reflect the distinct personality and expertise of the entity. The method is advantageous because it enables the creation of digital twins that can interact in a manner consistent with the original entity's characteristics, enhancing user engagement and providing a more authentic experience.

The arrangement of components involves using processors to collect and process data, train AI models, and generate software code. This integration ensures that the digital representation is not only accurate but also capable of dynamic interaction based on the trained model and processed content. Compared to existing solutions, this method offers a more comprehensive approach to digital representation by incorporating both psychometric and digital content elements, which are typically handled separately.

In practical application, this method can be used in educational settings to create digital twins of educators, allowing them to provide personalized learning experiences at any time from any computing device. For example, a digital twin of a professor could interact with students, answer questions, and provide feedback in a manner that mirrors the professor's teaching style and personality. This solves the problem of scalability in education by enabling consistent and personalized interactions without the need for the physical presence of the educator.

Throughout this disclosure, references to the techniques described herein being applicable to the education field are included, but it is contemplated that the same techniques could be applied to any field where consulting with an artificial intelligence system would be useful, including marketing, commerce, social, informational, or any other field in which expertise and intellectual property drive value and engagement in interactions.

The techniques of this disclosure relate to a technical system for creating personalized digital twins of educational experts through an advanced Neural Engine architecture that solves the technical problem of integrating multiple large language models (LLMs) with proprietary knowledge repositories while maintaining personality consistency. The techniques of this disclosure transform unstructured human expertise into structured, interactive digital representations that provide personalized educational experiences through a specific technical implementation.

In some examples, a computer-implemented system is configured to generate and operate an interactive digital representation of an entity. The entity may be a person, a group of persons, or an organization associated with subject-matter knowledge, communication characteristics, and behavioral tendencies. The interactive digital representation may be configured to respond to user inputs using one or more artificial intelligence (AI) models while exhibiting one or more psychometric characteristics derived from information about the entity, and while grounding at least a portion of its responses in digital content associated with, provided by, or otherwise representative of the entity.

In some examples, the system includes one or more computing devices having one or more processors, one or more memory devices, one or more storage devices, and one or more network interfaces. The computing devices may execute a communication module configured to manage interaction sessions with users, to receive user inputs, and to present outputs, and may execute an analysis module configured to generate or update a digital representation profile, to configure or train one or more AI models, to ingest and index digital content, to retrieve content responsive to queries, to invoke external tools, and to generate outputs for presentation. The modules may be implemented as software executing on general purpose processors, as dedicated-purpose circuitry, or as a combination thereof. The system may be implemented using a single computing device or a distributed computing environment including multiple compute nodes, and may be deployed in a cloud environment, an on-premises environment, or a hybrid environment.

In some examples, generating the interactive digital representation includes collecting psychometric elements associated with the entity. The psychometric elements may include personality traits, communication style, teaching methodology, mentoring approach, decision patterns, values, behavioral assessment information, responses to structured questionnaires, and information derived from interviews with the entity. The psychometric elements may additionally or alternatively include information derived from analysis of content authored by the entity or historically associated with the entity, such as writing samples, lecture transcripts, emails, messages, recorded audio, recorded video, or prior interactive sessions.

In some examples, the system collects psychometric elements using a structured assessment that includes multiple sections. A first section may collect personal identity information usable to parameterize an identity for the interactive digital representation. A second section may collect information indicating a personality type, including a typology classification. A third section may collect professional identity information, including a role of the entity and a purpose or objective for operating the interactive digital representation. A fourth section may collect knowledge and expertise information, including domains of expertise and a scope of coverage. A fifth section may collect mentorship approach information, including a coaching philosophy and ethical considerations. A sixth section may collect values and aspirations information, including values, conflict handling patterns, long-term aspirations, and work-life balancing approaches. A seventh section may optionally collect personal detail information, including routines, preferences, interests, and other personal characteristics, where such information may be used to improve personalization when permitted by privacy constraints.

In some examples, the system derives a personality profile from both explicit and implicit sources. The system may process a collection of entity content to extract linguistic features and recurring patterns, and may process entity interview data to extract explicit trait declarations. The system may map extracted traits to standardized trait dimensions, compute confidence scores for one or more traits, resolve conflicts between explicit and implicit indicators using weighted averaging, and normalize trait values. The system may generate a personality embedding vector representing the entity in a high-dimensional space. The system may validate the personality profile by generating one or more candidate responses using the personality profile and comparing the candidate responses to known entity responses, and may refine the profile when a similarity score fails to satisfy a refinement criterion.

In some examples, the system generates a set of model training instructions based at least in part on the psychometric elements. The model training instructions may include system prompt content, fine-tuning examples, adapter parameters, policy constraints, behavioral constraints, and configuration parameters. In some examples, the model training instructions are structured as a multi-section behavioral specification document defining one or more of mission and values, helpfulness standards, role hierarchy between administrative operators and end users, transparency requirements, safety boundaries, and requirements for maintaining consistency of tone, explanation depth, and teaching approach across sessions. Institution-level context data and user-level context data may be combined with the behavioral specification document to govern behavior of the interactive digital representation for a particular deployment.

In some examples, the system trains, fine-tunes, or otherwise configures an AI model using the generated model training instructions to form a trained AI model. The trained AI model may be configured to produce responses that conform to constraints of the behavioral specification document and that reflect one or more characteristics of the entity. The system may further maintain a digital representation profile that includes psychometric information, one or more model training instructions, one or more model identifiers, and one or more configuration parameters. In some examples, the system combines (i) knowledge grounding through digital content and (ii) personalization through psychometric elements to generate outputs that are both content-grounded and style-aligned with the entity.

In some examples, the system supports a plurality of large language models (LLMs) and is configured to operate in an LLM-agnostic manner. A first LLM may be used as a default model for generating responses. The system may receive user input requesting a switch to a second LLM, or the system may determine, based on characteristics of a prompt, that a second LLM is better capable of generating accurate output. In some examples, the system recommends a model switch using a human-in-the-loop control, for example when a performance history for a target domain indicates that a non-default model is preferable. In response to a model switch, the system may automatically apply the existing model training instructions and any additional information associated with the digital representation profile to configure the second LLM so that the interactive digital representation maintains consistent behavior across different underlying LLMs.

In some examples, the system additionally or alternatively combines outputs of multiple models. For example, the system may use an ensemble approach that applies a weighting algorithm to outputs from multiple models based on confidence scores. In other examples, the system may use a single model and apply a fine-tuning methodology that optimizes the model for different task categories. In some examples, different models may be assigned to different workflow roles, such as query analysis, retrieval planning, response generation, summarization, style alignment, or tool selection.

In some examples, the system collects digital content representative of the entity. The digital content may include content authored by the entity, content describing the entity, interviews with the entity, video content including the entity, audio spoken by the entity, audio spoken about the entity, images of the entity, course materials, institutional documents, policies, rubrics, frequently asked questions, and other digital materials from which relevant information can be extracted. The system may ingest content automatically through integration with an external platform or may ingest content through user upload, administrator upload, or automated crawling of approved sources.

In some examples, the system processes the digital content to develop accessible content readable by the trained AI model. Processing may include extracting text or other modalities, normalizing formats, segmenting documents into smaller segments, generating metadata, and creating indices. In some examples, the system chunks content into segments of approximately 8,191 bytes with contextual overlap between adjacent segments to preserve semantic coherence. When ingesting structured data such as comma-separated value (CSV) data, the system may preserve header information with chunks to enable the trained AI model to interpret fields within the chunk. The system may filter empty segments, sanitize segments to reduce inclusion of sensitive information while preserving semantic value, and submit segments to an embedding quality improvement model after ingestion.

In some examples, processing of digital content includes format-specific extraction workflows selected based on a detected file type, source type, or ingestion channel. For example, the system may apply optical character recognition to scanned documents or image-based documents, may extract message bodies and attachments from electronic mail containers, may expand compressed archives to obtain nested source files, and may retrieve transcripts or captions associated with remote audio or video content. The system may also normalize character encoding, convert source materials into a canonical internal representation, preserve structural markers such as headings, speaker identifiers, timestamps, or table relationships, and associate the structural markers with generated segments so that downstream retrieval and response generation preserve contextual meaning.

In some examples, the system applies source-aware preprocessing before generating embeddings or other retrieval-ready representations. Source-aware preprocessing may include separating boilerplate from substantive content, preserving document-level context for small segments, retaining field labels for structured records, associating page references or temporal references with extracted text, and identifying duplicate or near-duplicate content across ingested materials. Audio-derived content may be normalized by sample rate conversion, channel normalization, noise reduction, speaker diarization, or combinations thereof before transcription. These processing operations may improve quality of downstream indexing, retrieval, and grounding while preserving traceability to original source materials.

In some examples, the system transforms content segments into vector embeddings having dimensionality of approximately 1,536 dimensions or approximately 3,072 dimensions. The embeddings may be stored in a vector database and used to perform similarity comparisons. In some examples, the system performs similarity search using Euclidean distance and retrieves candidate segments using k-neighbor (kNN) techniques, exact neighbor (ENN) techniques, or combinations thereof. The system may apply one or more thresholds, including an administrator-configurable minimum relevance threshold, to control segment inclusion in a retrieved set.

In some examples, the system implements a secure knowledge compartmentalization architecture configured to prevent unauthorized exposure of proprietary content while enabling the interactive digital representation to access and use authorized content. In some examples, a protected repository, referred to herein as an intellectual property vault (IP Vault), stores proprietary digital content in a compartmentalized manner and isolates raw content from external models or services that are not authorized to access the content. The IP Vault may include encryption at rest and in transit and may support rotation of cryptographic credentials. In some examples, the IP Vault employs token-level security, such that access permissions are evaluated at a fine granularity for segments, tokens, or other small content units. Provenance metadata may be associated with segments or tokens to enable access verification based on content origin, ownership, trust tier, and contextual authorization.

The system may include a protected repository referred to as an intellectual property vault (IP Vault) that provides secure knowledge compartmentalization for digital content used by an interactive digital representation of an entity. The IP Vault stores, manages, and controls access to digital content associated with an individual, organization, course, project, or other knowledge source while limiting unauthorized exposure of such content to users, external systems, and artificial intelligence models. In operation, the IP Vault may isolate source materials from components that are not authorized to access the source materials directly, while still enabling retrieval-augmented generation workflows that use authorized information for response generation.

Digital content may be received at the IP Vault through multiple ingestion channels, including user uploads, administrator uploads, integrations with document repositories, integrations with communication systems, integrations with learning management systems, audio transcription pipelines, video transcription pipelines, and synchronized enterprise sources. The ingested content may include text documents, presentations, spreadsheets, transcripts, rubrics, policies, messages, recordings, structured datasets, and other materials representative of the entity's knowledge. The analysis module 222 may normalize file formats, extract text and metadata, segment content into content units, and associate each content unit with control attributes used for downstream authorization and policy evaluation.

The IP Vault may maintain content in a protected form using encryption, compartmentalized storage, and fine-grained access controls. Encryption may be applied to content at rest and in transit. Compartmentalized storage may separate content according to ownership, organizational boundary, assistant instance, trust tier, subject-matter domain, confidentiality level, or combinations thereof. Fine-grained access controls may be applied at a document level, segment level, token level, or combinations thereof so that different portions of the same source material are subject to different usage permissions.

In some examples, authorization is evaluated using a multi-layer authorization framework that applies account-level validation, resource-scope validation, and content-unit validation before protected content is released. Account-level validation may verify identity, role, subscription status, or programmatic access credentials associated with a requesting user, service, or tool. Resource-scope validation may determine whether the requesting context is permitted to access a repository, assistant instance, institution, course space, team space, or other organizational boundary associated with the protected content. Content-unit validation may evaluate whether a particular document, segment, token, field, or transformed representation is releasable for the current request based on provenance metadata, confidentiality classification, permitted-use rules, and session policy.

In some examples, different update and retrieval operations are subject to different authorization constraints. A first user or service may be permitted to retrieve selected content while being restricted from modifying metadata, promoting content across trust tiers, exporting content through a tool, or updating fields outside an allowed field set. Authorization state may be recalculated in response to changes in role information, policy changes, revocation events, or expiration of a credential or session token. By applying authorization at multiple levels of granularity, the system may prevent content exposure that would otherwise occur if access were controlled only at a repository or document level.

Each content unit stored in the IP Vault may be associated with provenance metadata. The provenance metadata may identify a source document, source owner, ingestion channel, organizational affiliation, trust tier, confidentiality classification, retention policy, and usage restrictions. The analysis module 222 may evaluate the provenance metadata during retrieval and response generation to determine whether a content unit is eligible for inclusion in a context package for a particular interaction session. In configurations that use token-level protection, the analysis module 222 may evaluate authorization at a granularity smaller than a document or segment so that release of protected material can be constrained with higher precision.

To support semantic retrieval while limiting exposure of raw content, the analysis module 222 may generate vector embeddings or other transformed representations of content units and store those transformed representations for similarity search. Retrieval operations may be executed against embeddings, indices, or other intermediate representations, and the IP Vault may release raw excerpts only when a content release policy permits disclosure for the current entitlement context. This arrangement enables semantic accessibility while preserving content protection boundaries.

The IP Vault may apply content transformations for broader access scopes. Content promoted or exposed at broader tiers may be released in a redacted form, an anonymized form, a summarized form, or another controlled representation that preserves semantic value while reducing disclosure of identifying or confidential information. The system may also enforce restrictions that reduce the likelihood of verbatim reproduction of protected passages in user-visible outputs, including quotation restrictions, overlap limits relative to protected text, synthesis requirements, and source-specific disclosure policies, unless verbatim reproduction is expressly authorized.

Specialized protections may be applied for content associated with real individuals. Content may be tagged with identity-linked restrictions that limit cross-organization reuse, cross-domain retrieval, training usage, or tool-based export. The system may distinguish among publicly attributable information, privately contributed information, institutionally controlled information, and inferred information derived from interaction history, and may apply different retrieval and output policies to each category.

Confidential interactions may be supported through ephemeral knowledge sessions. In an ephemeral session, the system may construct a temporary retrieval context from protected materials for completion of a request and limit persistence of the temporary retrieval context and related intermediate artifacts according to a session lifecycle policy. The lifecycle policy may define whether retrieved excerpts, summaries, cached states, and audit records are retained, truncated, encrypted, or deleted after the session ends.

In some examples, an ephemeral knowledge session is established using a temporary execution scope that is separate from persistent session memory. Retrieved excerpts, intermediate summaries, tool outputs, and model-ready context assembled for the ephemeral knowledge session may be stored only in volatile memory, may be encrypted with session-specific credentials, or may be deleted when a completion event, timeout event, or explicit termination event occurs. The system may further restrict persistent logging for the ephemeral knowledge session by storing audit metadata without storing protected content released during the session, or by storing only policy-decision records sufficient to demonstrate compliance.

In some examples, the session lifecycle policy defines different retention behaviors for different artifact types. For example, a policy may permit retention of access-decision metadata while requiring deletion of retrieved excerpts, may permit retention of redacted content while deleting unredacted content, or may permit a derived summary to be retained only if the derived summary satisfies a release rule associated with the underlying source materials. These controls allow the system to support confidential interactions while limiting persistence of sensitive content after the confidential interaction ends.

The IP Vault may provide governance, auditing, and policy enforcement. The system may log ingestion events, promotion events, access attempts, retrieval decisions, transformations such as anonymization, policy overrides, and output-generation events. The audit records may link generated outputs to protected source materials and applied authorization decisions to support compliance review and traceability.

The IP Vault may be implemented using one or more protected repositories, vector databases, metadata stores, indexing services, cryptographic material management services, and policy engines. The deployment topology may be centralized or distributed across multiple environments while preserving a common authorization framework. Through compartmentalized storage, provenance-aware authorization, fine-grained release controls, transformed representations for retrieval, and output controls, the IP Vault supports secure retrieval-augmented generation while preserving intellectual property rights, privacy constraints, and utility of underlying knowledge assets.

In some examples, the IP Vault enables the interactive digital representation to use protected knowledge with a level of control that is finer than conventional binary repository access. By combining compartmentalized storage, provenance-aware authorization, token-level verification, transformed representations for semantic retrieval, anonymization for broader access tiers, and output controls limiting unauthorized disclosure, the IP Vault may support secure retrieval-augmented generation while preserving intellectual property rights, privacy protections, and utility of the underlying knowledge assets.

In some examples, to reduce risk of content leakage, the system uses embeddings for retrieval and provides retrieved snippets to the trained AI model only when permitted by an access control policy. In some examples, the system transforms raw content into embeddings from which the original raw content cannot be reconstructed, and uses the embeddings for retrieval. In some examples, the system applies anonymization or redaction operations for broader access tiers, such as when content is shared beyond an originator's organization. In some examples, the system enforces compartmentalized knowledge boundaries for digital representations of real individuals, including constraints that restrict cross-domain retrieval, restrict retrieval from sensitive repositories, or require additional authorization. In some examples, the system supports ephemeral knowledge sessions for confidential materials such that a retrieval context is constructed for a session and is not persisted beyond a defined lifecycle.

In some examples, the system organizes accessible content into a hierarchical knowledge architecture referred to herein as a Tree of Knowledge. The Tree of Knowledge may define multiple tiers representing different access and trust levels. A first tier may include personal or user-specific repositories in which individuals maintain control over their content. A second tier may include instance-level repositories associated with a particular interactive digital representation, class, team, or project, enabling controlled sharing within that instance. A third tier may include organization-level repositories enabling controlled sharing across multiple instances within an organization. A fourth tier may include a community-level repository containing content selected for broad sharing across a platform. In some examples, the Tree of Knowledge enables controlled sharing across institutional boundaries while preserving intellectual property rights using tiered access controls.

In some examples, the system provides user-centered controls for content promotion within the Tree of Knowledge. Content may initially be retained at the personal tier. A user or administrator may promote content to an instance tier, an organization tier, or a community tier. In some examples, the system enables a user to convert a response generated by the interactive digital representation into a persistent document and to store that document in a repository for later reuse. In some examples, when content is promoted to the community tier, the content is evaluated using one or more governance controls, including automated screening, policy enforcement checks, and human review for selected cases. The system may apply classification tags to promoted content to improve discovery and to constrain usage to appropriate contexts.

In some examples, the system includes an intelligent response caching mechanism. The system may detect that a generated response or tool output exceeds a size criterion, such as an output exceeding approximately 10,000 characters, and may automatically store at least a portion of that output as a document in a repository of the Tree of Knowledge. This storage may prevent saturation of a context window of a model during a current interaction while preserving the content for subsequent retrieval. The system may additionally cache frequently accessed content, thereby reducing redundant processing for repeated or similar user queries.

In some examples, the intellectual property vault (IP Vault) operates in coordination with a hierarchical knowledge organization framework referred to as a Tree of Knowledge. The IP Vault may provide protected storage, access enforcement, provenance tracking, and output controls for digital content, while the Tree of Knowledge may provide a logical arrangement of such content across multiple sharing tiers, ownership domains, and trust levels. By combining the protection functions of the IP Vault with the hierarchical organization functions of the Tree of Knowledge, the system may enable an interactive digital representation to retrieve and use content with a level of granularity that reflects both content sensitivity and contextual relevance.

In some examples, the Tree of Knowledge defines a plurality of knowledge tiers through which content may be organized according to intended scope of access. A first tier may correspond to a personal or contributor-specific repository in which content remains associated with an originating user or source. A second tier may correspond to an instance-specific repository associated with a particular digital representation, course, project, or workflow. A third tier may correspond to an organizational repository associated with a business, institution, or other managed group. A fourth tier may correspond to a community repository containing content approved for broader distribution. The IP Vault may enforce distinct protection rules at each tier, such that the same underlying content management framework supports both highly restricted knowledge and more broadly shareable knowledge.

In some examples, content enters the Tree of Knowledge through an ingestion process controlled by the IP Vault. Upon ingestion, the system may assign each content item or content segment to an initial tier based on source identity, upload channel, declared permissions, content classification, or default governance rules. The IP Vault may associate the ingested content with provenance metadata identifying an owner, an origin, an applicable usage policy, and one or more promotion conditions. The Tree of Knowledge may then store a logical placement of the content within a designated branch or node corresponding to a subject matter area, organizational unit, assistant instance, or other contextual grouping. In this manner, the IP Vault governs protection attributes of the content while the Tree of Knowledge governs contextual placement and discoverability of the content.

In some examples, the Tree of Knowledge is not limited to simple folder-based organization, but instead may represent hierarchical and cross-linked relationships among knowledge assets. A content item may be associated with one or more parent nodes, child nodes, sibling nodes, topic nodes, and relationship edges that indicate semantic or administrative relationships. The IP Vault may preserve separate access rules for each content item or content segment regardless of the node structure in which the content appears. As a result, content may be discoverable through multiple branches of the Tree of Knowledge without losing the content-specific protections applied by the IP Vault.

In some examples, the system permits promotion of content from one tier of the Tree of Knowledge to another tier, while the IP Vault controls whether such promotion is authorized and under what conditions it occurs. A user, administrator, or automated governance process may request promotion of content from a personal tier to an instance tier, from an instance tier to an organizational tier, or from an organizational tier to a community tier. Before promotion is completed, the IP Vault may evaluate whether the content is eligible for broader distribution based on provenance metadata, intellectual property ownership, confidentiality rules, privacy restrictions, prior user consents, and organizational policies. The IP Vault may further require transformation of the content before promotion, such as anonymization, redaction, summarization, segmentation, or reclassification. After the transformation is completed, the Tree of Knowledge may update the logical placement of the promoted content while the IP Vault updates the permissions and protection state associated with the promoted version.

In some examples, promotion within the Tree of Knowledge does not require duplication of unrestricted raw content. The system may retain an original protected version of the content within the IP Vault and create a derived version for placement in a broader tier. The derived version may include a redacted form, an anonymized form, a summary form, an embedding-derived representation, or another controlled representation suitable for access at the broader tier. The Tree of Knowledge may maintain references linking the derived version to the original protected version, while the IP Vault prevents unauthorized traversal from the broader-tier version to the restricted original version. This arrangement may permit broad utility of knowledge while preserving stronger protection for the originating asset.

In some examples, the system also permits demotion, revocation, or reclassification of content previously placed within a tier of the Tree of Knowledge. If ownership changes, permissions expire, confidentiality status changes, or a policy violation is detected, the IP Vault may revoke access to a content item or may require removal of the content item from one or more tiers. The Tree of Knowledge may then update its logical structure to reflect the new classification, including removal of references, invalidation of cached retrieval entries, and restriction of downstream access paths. In this manner, the interaction between the IP Vault and the Tree of Knowledge may support a dynamic content lifecycle rather than a static repository model.

In some examples, retrieval from the Tree of Knowledge is mediated by the IP Vault. When a user submits a request, the system may determine an entitlement context for the request, including a user identity, a role, an organizational affiliation, a digital representation context, a session state, and one or more applicable usage policies. The Tree of Knowledge may identify candidate nodes, branches, or content units relevant to the request based on semantic matching, metadata matching, node relationships, historical usage, or contextual association. The IP Vault may then evaluate whether each candidate content unit is authorized for the entitlement context. Candidate units failing authorization may be excluded, replaced with transformed alternatives, or represented only through high-level metadata. Candidate units satisfying authorization may be released for ranking and inclusion in a context package provided to one or more artificial intelligence models.

In some examples, the Tree of Knowledge supports retrieval across multiple tiers, but the IP Vault controls cross-tier boundaries. A retrieval operation may begin at a most specific tier, such as a personal or instance-specific tier, and may expand to broader tiers when sufficient responsive content is not found or when policy rules permit broader contextual supplementation. The IP Vault may enforce inheritance rules according to which more restrictive content remains dominant over broader content for users entitled to the restrictive tier, while broader-tier content may be used as fallback material when narrower tiers do not provide a sufficient basis for response generation. The system may thereby preserve a preference for contextually proximate and authorized knowledge while still benefiting from broader knowledge resources where permitted.

In some examples, the Tree of Knowledge and the IP Vault cooperate to support source ranking and trust-weighted retrieval. The Tree of Knowledge may provide structural indicators such as node depth, branch relevance, node authority, and relationship proximity. The IP Vault may provide protection indicators such as trust tier, provenance confidence, policy compatibility, and disclosure constraints. The retrieval pipeline may combine structural indicators from the Tree of Knowledge with protection indicators from the IP Vault to generate a ranking score for candidate content. For example, content located in a highly relevant branch but subject to limited disclosure may be ranked lower or transformed before use, whereas content in an authorized branch with strong provenance and high contextual relevance may be prioritized. This combined ranking approach may improve both security and response quality.

In some examples, the Tree of Knowledge serves as a framework for persistent organizational memory, while the IP Vault governs which portions of that memory may be used in a given interaction. A response generated during an interaction may itself become a new knowledge asset. The system may store the generated response, an associated summary, or an extracted structured representation within a selected branch of the Tree of Knowledge. Before such storage occurs, the IP Vault may determine whether the generated response includes restricted source material, whether user-generated contributions alter ownership status, and whether downstream reuse is permitted. The IP Vault may then classify the generated asset and apply retention and disclosure policies before the Tree of Knowledge makes the asset available for future retrieval.

In some examples, the Tree of Knowledge may include branch-specific governance rules, and the IP Vault may enforce such rules at a content level. A branch corresponding to a regulated subject matter area, confidential project, or restricted institutional function may have stricter promotion thresholds, disclosure policies, and retention periods than a branch corresponding to broadly shareable educational content. The IP Vault may evaluate branch-specific rules during ingestion, promotion, retrieval, and output generation. Thus, the Tree of Knowledge may define contextual governance zones, and the IP Vault may apply the fine-grained operational controls needed to implement those zones.

In some examples, the interaction between the Tree of Knowledge and the IP Vault supports collaborative content development without sacrificing ownership boundaries. Multiple contributors may submit content associated with a shared branch of the Tree of Knowledge, such as a course branch, project branch, or organizational branch. The Tree of Knowledge may expose the branch as a shared knowledge space for discovery and retrieval. The IP Vault may nonetheless preserve separate provenance chains, contributor-specific permissions, and source-specific usage rules for the underlying assets. Accordingly, the system may permit a collaborative knowledge space to exist at the logical level while retaining content-specific access protections at the storage and retrieval level.

In some examples, the system uses the Tree of Knowledge to determine contextual adjacency among knowledge assets and uses the IP Vault to determine whether such adjacency may be traversed during retrieval. A candidate content unit may be relevant because it is directly responsive to a query, because it is related through a parent-child or sibling relationship, because it is linked by a dependency edge, or because it has been used in prior successful responses within the same branch. The Tree of Knowledge may surface these related assets as candidate materials. The IP Vault may then determine whether the current entitlement context permits traversal to each related asset and whether the permitted form of access is full access, transformed access, metadata-only access, or no access. This controlled traversal may allow the system to exploit graph-like structure without violating content restrictions.

In some examples, the Tree of Knowledge and the IP Vault cooperate to support caching and response reuse. A previously generated response may be cached in association with one or more branches of the Tree of Knowledge and with one or more entitlement profiles. When a later request is received, the Tree of Knowledge may identify the cached response as relevant based on branch placement, topic similarity, or prior usage. The IP Vault may evaluate whether the later request is covered by the entitlement profile associated with the cached response or whether a new filtered or transformed version is required. As a result, the system may improve efficiency through controlled reuse while preserving access constraints.

In some examples, the Tree of Knowledge may be distributed across multiple institutions, organizational domains, or computing environments, while the IP Vault maintains domain-specific protections. The system may permit federated querying across multiple branches maintained by different entities, but the IP Vault of each entity may independently determine what content or transformed representations may be contributed to a federated retrieval result. The resulting context package may therefore include content from multiple domains, each governed by its respective protection controls, while the Tree of Knowledge provides a unified logical structure for locating and relating the content.

In some examples, auditability is strengthened by the interaction between the Tree of Knowledge and the IP Vault. The Tree of Knowledge may record where a content item is placed, which branches reference the content item, and how the content item participates in retrieval pathways. The IP Vault may record who ingested the content item, which policies were applied, whether the content item was promoted or transformed, and under what authorization conditions the content item was released for use. Together, these records may enable traceability from a generated output back to a branch of the Tree of Knowledge and back to a protected source managed by the IP Vault, thereby supporting governance, compliance review, and dispute resolution.

In some examples, the interaction between the IP Vault and the Tree of Knowledge enables the system to distinguish between discoverability and accessibility. A content item may be discoverable in the sense that a relevant branch or node indicates the existence of potentially useful information, while the content item may remain inaccessible in full because the IP Vault determines that the current interaction context does not satisfy release conditions. In such cases, the system may provide an alternative action, such as retrieving a permitted summary, retrieving an anonymized version, signaling that additional authorization is required, or selecting substitute content from a broader tier. This distinction may improve user experience while preserving security and intellectual property boundaries.

In some examples, the IP Vault and the Tree of Knowledge collectively provide a knowledge lifecycle in which content is ingested, classified, protected, organized, promoted or transformed, retrieved under entitlement-aware conditions, incorporated into model context under output controls, and optionally persisted as new knowledge assets subject to renewed classification and protection. By assigning the Tree of Knowledge to the role of contextual organization and assigning the IP Vault to the role of protected storage and policy enforcement, the system may provide a scalable and secure architecture for retrieval-augmented generation using knowledge assets that vary in ownership, sensitivity, and intended scope of reuse.

The system may implement a retrieval pipeline that cooperates with the IP Vault and the Tree of Knowledge to generate responses to requests received from user devices. The communication module 220 may receive a request and establish or update a session context that includes user identity, role attributes, organizational affiliation, a digital representation identifier, conversation state, and policy constraints. Requests received in an audio modality may be converted into a text representation for downstream processing, and outputs may be formatted for text presentation, speech synthesis, or both.

The analysis module 222 may perform query analysis to determine intent, subject matter domain, sensitivity classification, complexity level, and whether a request is likely to require tool invocation. Query analysis may also produce a retrieval plan, including one or more query embeddings, one or more keyword expressions, metadata filters, temporal constraints, and branch-selection parameters.

The Tree of Knowledge may guide selection of candidate branches, nodes, and knowledge assets. Traversal may begin at a branch associated with a current digital representation, course, project, or user and may expand to related nodes when additional context is required. Candidate knowledge assets may be identified using multiple retrieval mechanisms, including semantic retrieval over vector embeddings, keyword or metadata retrieval, and relationship-based retrieval using node relationships or structured links.

Candidate knowledge assets identified through the Tree of Knowledge and retrieval mechanisms may be subjected to authorization filtering by the IP Vault. The IP Vault may evaluate release conditions based on provenance metadata, ownership, trust tier, organizational boundary, retention status, and entitlement compatibility. Authorization decisions may be applied at a document level, segment level, token level, or combinations thereof. Content that is not authorized may be excluded, replaced with a transformed representation, or represented by a restricted indicator that responsive information exists but is not available for disclosure under the current session policy.

After authorization filtering, the analysis module 222 may rank remaining candidates and select a subset for inclusion in a context package. Ranking may consider semantic relevance, structural proximity within the Tree of Knowledge, provenance confidence, trust tier, freshness, authoritativeness, historical usefulness, and expected contribution to completeness. The analysis module 222 may deduplicate candidates and apply diversity controls to reduce redundancy.

The context package may be constructed from authorized excerpts, transformed excerpts, metadata, conversation-state summaries, behavioral control data, and tool availability information. The analysis module 222 may enforce a context budget associated with a selected artificial intelligence model and may summarize or compress lower-priority materials while preserving higher-priority materials in greater fidelity.

A model selection operation may choose one or more artificial intelligence models based on request characteristics, sensitivity constraints, latency targets, and performance history. The analysis module 222 may generate an output using the selected model and transmit the output to the communication module 220 for presentation to the user device. Output controls may be applied before presentation, including constraints on quotation, overlap with protected text, and synthesis requirements, to reduce unauthorized disclosure of protected materials.

Tool invocation may be integrated into the retrieval pipeline. Tool requirements may be identified during query analysis, during candidate ranking, or during response generation. The analysis module 222 may generate structured tool requests, the communication module 220 may transmit tool requests to external services when permitted, and returned tool outputs may be subjected to policy checks and incorporated into a revised context package for continued generation.

Interaction artifacts may be stored for performance and governance. The system may persist retrieval paths, candidate identifiers, authorization decisions, context package summaries, generated outputs, and audit records linking outputs to underlying sources. Cached artifacts may be reused for subsequent similar requests when entitlement conditions are compatible, and the IP Vault may enforce whether reuse is permitted. Generated outputs, summaries, or structured extractions may be ingested as knowledge assets under governance rules to support a closed-loop knowledge lifecycle.

In some examples, a generated response or a derived summary of the generated response may itself become a new knowledge asset. Before such an asset is added to the Tree of Knowledge, the IP Vault may determine whether the asset contains restricted content inherited from source materials, whether the asset is eligible for storage in a particular tier, and whether the asset should be stored in original, summarized, or transformed form. The Tree of Knowledge may then place the new asset in a branch corresponding to a subject matter area, a digital representation, a project, or an organizational function. The system may thereby create a feedback loop in which interaction results enrich the knowledge environment over time while remaining subject to the same protection and governance controls applied to originally ingested content.

In some examples, the retrieval pipeline supports conversational continuity across multiple interactions. The system may maintain a session memory including prior requests, prior responses, prior retrieval paths, and prior authorization states. When a new request is received, the system may use the session memory to refine branch traversal within the Tree of Knowledge, to prioritize knowledge assets previously found useful, and to avoid repeating disallowed access attempts previously rejected by the IP Vault. The session memory may itself be summarized or compacted when it approaches a context limit, and the summarized form may be treated as an additional controlled knowledge asset subject to protection and reuse rules.

In some examples, the interaction of the retrieval pipeline with the IP Vault and the Tree of Knowledge enables the system to distinguish among discoverability, authorization, and presentation. The Tree of Knowledge may indicate where responsive knowledge is likely to reside, the IP Vault may determine what portion of that knowledge may be released for the current request, and the generation process may determine how authorized knowledge is to be presented in a response. Because these functions are separated but coordinated, the system may generate responses that are contextually grounded, entitlement-aware, structurally informed, and less likely to disclose protected information outside an authorized scope.

In some examples, the system uses a source prioritization hierarchy to rank accessible content sources when generating a response. The system may rank sources based on multiple factors, such as semantic similarity between a query and candidate content, institutional priority weights, content freshness factors, and authority scores. In some examples, the system computes a final score for candidate sources as a weighted combination of factors, for example a function of a semantic relevance score, an institutional priority weight, a recency factor, and an authority score. The system may also apply a diversity adjustment to promote a set of sources that collectively cover relevant aspects of a query.

In some examples, the system processes a user query through a query-processing flow. The system may authenticate a user, retrieve user context, and analyze a query using natural language processing to determine intent, a domain, and a complexity level. The system may select candidate sources based on domain relevance scores, institutional priority weights, and source freshness factors. In an example scoring function, a final source score may be computed as FSS=DRS×0.5+IPW×0.3+SFF×0.2, where DRS is a domain relevance score, IPW is an institutional priority weight, and SFF is a source freshness factor. The system may select a model based on performance history for the domain and may generate a base response using the selected model and selected sources. The system may apply a personality transformation to the base response based on the personality profile, including extracting linguistic patterns from the profile and applying a style transfer function to adapt the base response while preserving substantive content, and may adjust an explanation level based on the complexity level.

In some examples, the system uses a personality modeling algorithm that processes expert content and expert interviews to generate a personality profile. The system may extract linguistic features, identify recurring patterns, compute a feature frequency distribution, extract explicit trait declarations, map the declarations to standardized trait dimensions, compute trait confidence scores, resolve conflicts using weighted averaging, and normalize trait values to a defined range. The system may generate a personality embedding vector and validate the profile using similarity testing with known expert responses.

In some examples, the system includes an orchestration layer referred to herein as a neural engine that coordinates interactions between models, specialized agents, secure repositories, and external tools. The neural engine may function as a communication bus that receives interaction events, performs authorization checks, invokes retrieval operations, constructs prompts, dispatches model requests, manages tool invocations, and streams responses. In some examples, the neural engine includes a centralized orchestration layer with a message broker that routes queries and responses using a priority-based queue. In other examples, the neural engine is distributed and includes edge processing nodes that execute portions of a pipeline, and may implement synchronization protocols for scalability. In some examples, the neural engine includes specialized sub-engines that perform domain-specific processing or tool-integrated processing using standardized connectors.

In some examples, the system supports agentic task execution by the interactive digital representation. An agentic task may include a task for which the system plans and executes a sequence of operations to achieve an objective, including decomposing a task into sub-tasks, selecting tools, invoking tools, interpreting returned results, and generating an output. Agentic tasks may include answering questions, generating lesson plans, grading assignments, moderating discussions, writing assignments, generating quizzes, creating tutoring plans based on prior performance, and monitoring user performance. In some examples, a dynamic task is performed autonomously without real-time human supervision subject to boundaries defined by a behavioral specification document. Content generated during performance of a task may be routed through a document ingestion pipeline for indexing within accessible content to create a closed-loop knowledge lifecycle.

In some examples, the system includes a tool integration framework enabling the interactive digital representation to interact with external applications and services. Tools may include research and knowledge tools, browser and URL-reading tools, mapping and location tools, image generation and analysis tools, specialized search tools, educational platform tools, and data management tools. In some examples, tools include functions for reading a URL, performing a search, retrieving academic publications, retrieving patents, retrieving videos, retrieving location information, performing database queries, creating visualizations, storing user memory, retrieving user memory, calling a learning management system, searching content of a learning management system, transcribing audio, and invoking retrieval-augmented generation pipelines. Tool access may be controlled by entitlements and trust tiers.

In some examples, the system integrates the interactive digital representation with a learning management system (LMS) using a protocol translation layer. The protocol translation layer may enable access to course materials, assignments, rubrics, and role information, and may permit the interactive digital representation to post outputs, such as feedback, grades, messages, or recommendations. In some examples, integration includes an approach that injects code at a theme level, integration using an interoperability protocol with authentication extensions, integration using a REST application programming interface with caching, integration using direct database synchronization with a data transformation layer, or combinations thereof. In some examples, voice-enabled interfaces are integrated through audio processing components to support transitions between text and voice interactions.

In some examples, the system implements a role-based entitlement framework that manages access to resources and functionalities. The entitlement framework may include permission matrices stored in a data store optimized for attribute queries, a rule engine configured to evaluate permissions in real time, and a caching layer with invalidation logic. Entitlements may depend on user attributes, course membership, organizational affiliation, subscription information, and temporal constraints. The entitlement framework may support delegation controls, audit logs, and synchronization with role definitions maintained by an external platform.

In some examples, the system exposes a programmatic interface through a software development kit (SDK) enabling headless operation and automated workflows. The SDK may expose services via one or more network protocols, including REST and gRPC, may support authentication using signed tokens with granular permission scopes, may support API versioning, and may implement rate limiting and quota management. The SDK may support streaming for real-time data processing and may enable webhook-driven event subscriptions. In some examples, the SDK supports event-driven triggers for agentic workflows and state persistence for long-running workflows.

In some examples, the programmatic interface supports embedded deployment of the interactive digital representation within a third-party application, website, course environment, enterprise portal, or mobile application. A host environment may initiate a client session for a particular user, course, workspace, or assistant instance and may pass session-scoped context, identity assertions, role information, or policy attributes to the disclosed system. Federated authentication may be supported through single sign-on mechanisms, delegated authorization flows, signed launch tokens, or combinations thereof so that a user authenticated by a host platform may be recognized without requiring a separate credential exchange through the interaction interface.

In some examples, the system maintains client-session state independently from model inference state. A client session may identify a requesting application instance, a presentation surface, a time-bounded session window, and one or more permissions applicable to the client environment. Separation of client-session state from model inference state may permit the same interactive digital representation to operate concurrently across multiple surfaces while preserving independent authorization, logging, throttling, and content-release behavior for each client session.

In some examples, the system includes a proactive engagement capability. The system may include a prediction engine configured to identify an opportunity for an AI-initiated interaction, generate a contextually appropriate conversation starter, and schedule or transmit a follow-up message. Proactive engagement may be constrained by role-based entitlements and may be disabled for certain users or contexts.

In some examples, the system includes adaptive learning support. The system may apply pattern recognition to user interaction history to identify learning preferences, knowledge gaps, and mastery levels for objectives. The system may store preferences in persistent user memory and may generate personalized interventions. In an example adaptive learning flow, the system analyzes interaction history to extract performance metrics, identifies knowledge gaps, maps gaps to learning objectives, computes mastery levels, selects priority objectives, determines a preferred explanation style, selects content formats, adjusts explanation depth, schedules review intervals, and outputs a personalized learning plan.

In some examples, the system supports a conversational voice interface. The system may receive audio input, apply automatic speech recognition to generate text, perform retrieval and response generation based on the text, and apply text-to-speech synthesis to generate audio for output. The system may use speech recognition models optimized for domain terminology and may use voice synthesis models configured to produce voice output consistent with a personality profile. In some examples, the system applies emotion detection to modulate responses based on detected user affect. In some examples, the system supports a visual representation of the interactive digital representation, including an avatar, and may animate the avatar by determining articulation states based on generated audio.

In some examples, the system includes performance optimizations. The system may perform load balancing to distribute computational tasks across multiple processors or nodes. The system may dynamically allocate computational resources based on query complexity, content sensitivity, and latency objectives, and may adjust processing power to reduce energy consumption during peak usage periods. The system may implement adaptive algorithms to streamline data processing for complex queries. The system may use machine learning techniques to predict and pre-fetch frequently accessed data to minimize latency.

In some examples, the system maintains conversational continuity by storing interaction history and generating a compact representation of earlier exchanges when accumulated interaction content approaches a context window threshold. The system may store the compact representation in a persistent cache and may insert the compact representation into subsequent prompts to enable multi-session coherence exceeding an individual model context window.

In some examples, the system streams model responses and partitions a streamed response into a stable region and a modifiable region. The system may advance a boundary between the regions using content-aware detection that preserves structured formatting integrity, and may cache stable content. Such response streaming controls may improve responsiveness while permitting incremental revision of a response during generation.

In some examples, one or more components are implemented using containerized microservices and are deployed using an orchestration platform. The system may mount temporary storage for intermediate processing. Model integrations may be managed by an API connection manager that supports authentication using rotating credentials, request rate limiting, and caching with time-to-live settings. Secure knowledge repositories may be implemented using a distributed database and indices configured for vector search, and may include query performance constraints. The system may implement encryption with a cryptographic material management system, and may support automatic failover and availability targets. In some examples, the system employs federated learning to keep institutional data local while enabling model improvement, or employs differential privacy techniques for training while protecting sensitive information.

In some examples, the functions described herein are performed in various sequences and combinations, and modules may be combined, subdivided, or distributed. Any of the techniques described herein may be implemented using hardware, software, firmware, or combinations thereof, and may be stored as instructions on non-transitory computer-readable media for execution by one or more processors.

The system may include a provider-agnostic orchestration layer configured to interface with a plurality of artificial intelligence model providers through middleware components that normalize request formatting, response parsing, streaming behavior, credential handling, and error handling. The orchestration layer may support model routing among a plurality of language models, embedding models, speech models, summarization models, or combinations thereof based on use-case category, quality targets, cost targets, latency targets, or policy constraints. A normalized reasoning-effort control may be supported and translated into provider-specific parameters so that a selected level of processing can be preserved across different underlying providers.

In some examples, the middleware components include provider-specific adapters that translate a common internal request format into provider-specific request payloads and translate provider-specific responses into a normalized internal response format. The provider-specific adapters may account for differences in parameter names, message structure, tool-calling schema, streaming protocol, safety settings, system-instruction format, token budgeting, or error reporting conventions among different providers. The orchestration layer may thereby permit the system to preserve a common interaction pipeline while switching among different underlying model providers.

In some examples, credential handling is performed using a hierarchical credential resolution process. The orchestration layer may first determine whether an assistant-specific credential is assigned for a requested provider, then determine whether an organization-level or tenant-level credential is assigned, and then determine whether a platform-level credential is available as a fallback. Credential selection may further depend on a trust tier, a jurisdictional restriction, a workload category, a billing rule, or a security policy. The resolved credential may be used together with provider-specific policy settings so that model access, tool availability, and content-release behavior remain consistent with the authorization context of the interaction.

In some examples, the normalized reasoning-effort control corresponds to an internal reasoning level that is mapped to provider-specific controls for context length, inference budget, iterative processing depth, response latency target, or combinations thereof. A first provider may implement the internal reasoning level using a first set of parameters, while a second provider may implement the same internal reasoning level using a different set of parameters. This arrangement may enable the system to preserve a selected processing depth across provider changes without requiring a user or administrator to understand provider-specific parameter definitions.

Tool integration may be implemented through a dynamic tool registration architecture through which external services expose tools to the interactive digital representation through a standardized protocol. A tool registration record may identify a remote service, authorization parameters, approval requirements, and tool definitions. The system may discover available tools from a registered service, translate tool definitions into a tool-calling schema compatible with an active model, and route tool invocations to the external service without requiring modification of platform code.

In some examples, a tool registration record includes a network address of an external service, a transport protocol definition, one or more authentication parameters, one or more tool identifiers, one or more tool schemas, and one or more policy attributes controlling invocation of the external service. The system may periodically query the external service or receive a registration update from the external service to determine whether new tools, revised tool definitions, or revised invocation parameters are available. Newly discovered tools may be added to the available tool set without requiring modification of platform code for each newly available tool.

In some examples, tool invocation is governed by approval requirements and invocation policies associated with a registered tool or registered service. A policy may define whether a tool is available only to specified roles, only within specified organizational scopes, only for specified task types, only after satisfaction of a human approval requirement, or only when the current provider supports a compatible tool-calling mode. The system may further maintain an allowlist or denylist of tools for a particular assistant instance, institution, team, or interaction surface. Before invocation, a selected tool definition may be translated into a schema compatible with an active model provider so that model-generated tool calls can be validated and routed according to a provider-specific tool-calling format.

Extended interaction history may be managed using a history-compaction subsystem having a persistent multi-state cache. When accumulated conversation history approaches a context threshold associated with a selected model, the system may generate a compacted representation of older exchanges while preserving more recent exchanges in greater fidelity. The cache may support reuse of previously generated compacted representations for matching or partially matching history ranges and may invalidate a cached compacted representation responsive to message deletion, reordering, or satisfaction of a recompaction criterion.

In some examples, the persistent multi-state cache distinguishes among an exact-hit state, a partial-hit state, and a cache-miss state. In the exact-hit state, the system may reuse a previously generated compacted representation for a history range that matches a current history range. In the partial-hit state, the system may reuse a previously generated compacted representation for an earlier portion of the history range and may compact only a more recent unmatched portion. In the cache-miss state, the system may generate a new compacted representation for the relevant portion of the interaction history.

In some examples, recompaction is triggered when one or more thresholds are satisfied, including a token threshold, a message-count threshold, a semantic-drift threshold, or a recency threshold associated with unsummarized exchanges. The system may preserve structured artifacts such as lists, tabular information, quoted terms, or identifiers during compaction so that a reused compacted representation remains useful for later prompt construction. Cached compacted representations may be invalidated when deletion, insertion, reordering, or policy changes affect the historical range represented by the cached compacted representation.

Subsystem coordination may be performed through an event-driven communication bus that coordinates interaction management, retrieval, prompt construction, model dispatch, tool execution, response streaming, and persistence. By routing interaction events through the communication bus rather than point-to-point coupling, the system supports independent scaling and replacement of subsystems while preserving a unified authorization and governance framework.

A multi-tier file access framework may be applied to content associated with the interactive digital representation. Files may be classified into access tiers including broadly accessible, authenticated shared, and restricted confidential tiers. The system may support different authentication pathways for human-initiated requests and tool-initiated requests while applying a common authorization cascade that evaluates ownership, organizational scope, confidentiality classification, and administrative privileges before releasing content.

Post-ingestion quality management may be applied to knowledge segments after an initial chunking and embedding process. Segments may be sanitized to remove artifacts, normalize formatting, condense redundant boilerplate, and resolve encoding anomalies while preserving semantic content. Segments that lack substantive content may be excluded from indexing, and the system may selectively reprocess segments or re-ingest documents to regenerate segment content using updated processing parameters.

In some examples, the structured knowledge graph layer is generated using extraction operations constrained by source materials rather than unconstrained generative inference. An extraction model or parsing pipeline may identify entities, attributes, relationships, and event references from source-document text spans and may associate extracted graph elements with citations to corresponding spans, documents, timestamps, or page locations. The system may thereby preserve traceability between a graph element and an originating source passage and may distinguish extracted facts from inferred or user-supplied information.

In some examples, the structured knowledge graph layer maintains temporally scoped information so that a relationship, status, or attribute may be associated with an effective date, publication date, event time, or validity interval. In response to a query, the system may activate semantic vector retrieval, graph traversal, and keyword or metadata retrieval in parallel and may combine results using rank-based fusion followed by reranking. Because graph elements may remain linked to source-document spans, the system may assemble a grounded context package that includes both structured signals and source-derived textual support for use in generation of a response.

A knowledge feedback pipeline may store generated outputs as knowledge assets. A model-generated report, analysis, lesson material, or other output may be rendered into a persistent document and routed through a document ingestion pipeline for indexing as accessible content. Storage of such generated content may be conditioned on governance rules and access policies so that reuse is controlled.

A structured knowledge graph layer may be generated from ingested source materials and used together with document retrieval. In response to a query, the system may activate multiple retrieval pathways in parallel, including semantic vector retrieval, graph-based traversal using one or more seed entities, and keyword or metadata retrieval. Results from the retrieval pathways may be unified using rank-based fusion and refined using a reranking model, thereby providing structured memory that complements document retrieval and supports continuity across interaction surfaces.

Real-time voice interaction may be supported through a hybrid pipeline in which speech recognition and speech synthesis are performed by a voice services layer while reasoning, retrieval, tool use, and behavioral control are performed by the platform processing stack. Session-level context may be retained across voice turns, and the system may generate persona-consistent spoken acknowledgments during tool execution delays. Voice output may be synthesized using a voice model associated with the entity, including a synthesized voice model trained from audio recordings associated with the entity.

In some examples, voice interaction is supported through a plurality of real-time speech interaction protocols. A first protocol may support bidirectional streaming audio between a client device and a platform service, a second protocol may support segmented or turn-based speech exchange, and a third protocol may support browser-based audio transport or telephony-oriented transport. The disclosed system may operate in a hybrid mode in which speech recognition and speech synthesis are performed by a voice services layer while reasoning and retrieval are performed by the platform processing stack, or may operate in a mode in which a provider performs a larger portion of the speech pipeline while the platform retains control over retrieval grounding, policy enforcement, and tool governance.

In some examples, a voice session retains session-scoped context across multiple spoken turns and may support tool invocation during the voice session. The system may convert retrieved text into a speech-oriented representation by adjusting punctuation, abbreviation expansion, sentence segmentation, confirmation phrasing, or interruption handling so that generated speech remains intelligible and aligned with the entity profile. The system may further provide spoken acknowledgments, partial confirmations, or delay-handling utterances while a retrieval operation or tool invocation is pending.

A visual representation of the entity may be supported through an avatar animation pipeline. The animation pipeline may derive articulation states from generated audio and control facial expressions or pose variations based on emotion indicators derived from generated text or other signals. A multi-dimensional interactive digital representation may combine psychometric personality, domain knowledge, voice identity, and visual representation within a common entity profile, and different deployments may enable different subsets of these dimensions based on policy and resource constraints.

In some examples, the visual representation of the entity is generated or configured using one or more reference images, one or more videos, one or more biometric descriptors, or combinations thereof. A visual asset generation process may derive a base avatar model, facial landmarks, texture data, or animation parameters from the reference material and may adapt the generated visual representation for different rendering tiers ranging from a low-compute static or limited-animation mode to a higher-compute mode supporting richer facial motion, pose variation, or environmental integration. The selected rendering tier may depend on network conditions, hardware capability, policy constraints, or a target presentation surface.

In some examples, the multi-dimensional interactive digital representation includes psychometric behavior modeling, knowledge grounding, voice identity, and visual representation as separate but coordinated dimensions of an entity profile. A first deployment may enable only knowledge grounding and psychometric behavior, a second deployment may additionally enable voice identity, and a third deployment may further enable a visual representation. Audio-driven articulation may be controlled using phoneme timing, viseme states, stress patterns, pause timing, or combinations thereof, while expression changes may be influenced by emotion indicators, interaction state, or conversational context.

Streamed response rendering may be optimized by partitioning incremental output into a stable region and a modifiable region. A boundary between the regions may be advanced using content-aware criteria that avoid splitting incomplete formatting constructs, and the stable region may be cached to reduce repeated parsing, rendering, and transmission of finalized content.

In some examples, content-aware criteria used to advance the boundary between the stable region and the modifiable region include detection of completed sentences, completed paragraphs, completed list items, completed table rows, completed markup constructs, or combinations thereof. The system may refrain from advancing the boundary when a candidate boundary would split a code block, table structure, citation marker, hyperlink construct, or other formatting element whose partial rendering would degrade presentation integrity. The stable region may therefore correspond to a prefix of the streamed response that has reached a formatting-safe and semantically coherent state for one-time rendering.

In some examples, the streamed response rendering process further includes periodic reconciliation against an authoritative accumulated response state. During reconciliation, the system may compare a locally rendered modifiable region with an updated authoritative response string and may replace, truncate, or extend the modifiable region if divergence is detected. The system may also selectively bypass one or more downstream rendering operations when the streamed output does not require format-specific transformation, thereby reducing repeated parsing and improving responsiveness of incremental presentation.

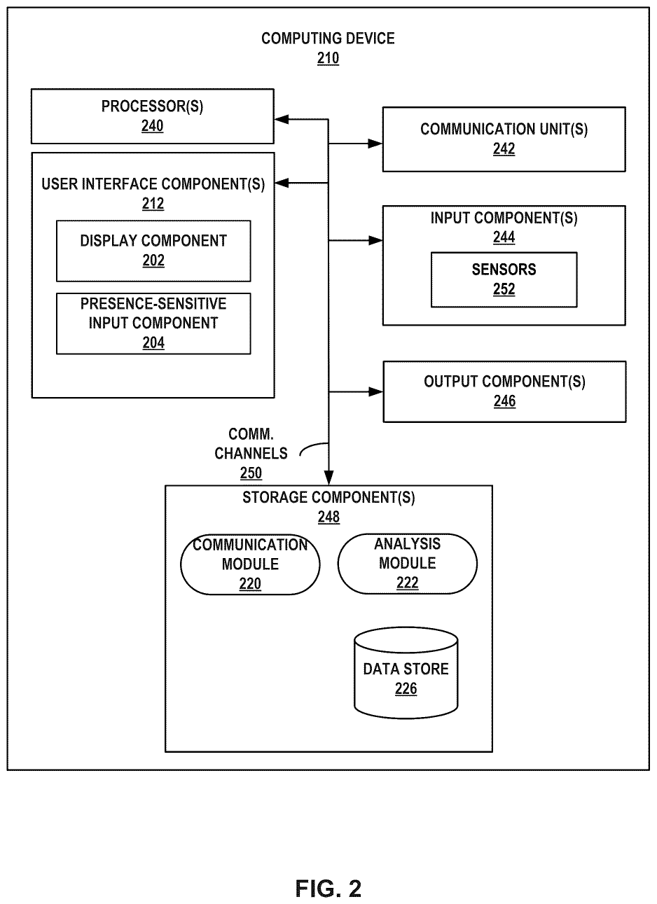

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smart home component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to generate and utilize digital representations of entities.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to generate and utilize digital representations of entities

Communication module 220 may execute locally (e.g., at processors 240) to provide functions associated with managing a user interface, gathering data, and outputting data. In some examples, communication module 220 may act as an interface to a remote service accessible to computing device 210. For example, communication module 220 may be an interface or application programming interface (API) to a remote server that manages a user interface, gathers data, and outputs data.

In some examples, analysis module 222 may execute locally (e.g., at processors 240) to provide functions associated with training and utilizing digital representations of entities. In some examples, analysis module 222 may act as an interface to a remote service accessible to computing device 210. For example, analysis module 222 may be an interface or application programming interface (API) to a remote server that trains and utilizes digital representations of entities.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, computing device 210 and its various modules and components may perform any portion or all of any of the techniques described herein. The communication module 220 manages interaction sessions with one or more user devices, including receiving user inputs, presenting outputs, managing session state, coordinating authentication and authorization exchanges, and managing network connectivity for integrations with external systems. The analysis module 222 performs AI-related and knowledge-related operations used by the interactive digital representation, including collecting and processing psychometric elements, generating model training instructions, training or configuring one or more artificial intelligence models, ingesting and processing digital content representative of the entity, performing entitlement-aware retrieval and ranking, constructing prompts and context packages, invoking tools when permitted, and generating outputs for delivery via the communication module 220. The communication module 220 and the analysis module 222 may execute as separate processes, separate services, or on separate computing nodes, while cooperating through one or more internal interfaces to exchange requests, context, and results.

Psychometric data and other entity-related inputs may be received through interaction sessions, administrative interfaces, or integrations with third-party systems. The communication module 220 may receive such inputs and forward the inputs to the analysis module 222. The analysis module 222 may derive psychometric elements including personality traits, communication style, mentoring or teaching methodology, behavioral assessment information, interview-derived information, and content-derived information. The analysis module 222 may generate model training instructions based at least in part on the psychometric elements. The model training instructions may define behavioral constraints and response policies that specify tone, explanation depth, role constraints, transparency rules, and safety boundaries. The analysis module 222 may train or configure an artificial intelligence model using the model training instructions to produce a trained artificial intelligence model configured to generate responses aligned with one or more psychometric characteristics of the entity.

Digital content representative of the entity may be collected from content sources including file uploads, institutional repositories, approved web-accessible sources, communication platforms, and learning management systems. The communication module 220 may obtain content through one or more ingestion interfaces and provide the content to the analysis module 222. The analysis module 222 may process the content to produce accessible content readable by the trained artificial intelligence model, including parsing, normalization, segmentation, enrichment with metadata, indexing, and generation of machine-readable representations. Vector embeddings may be generated for content segments and stored in an embedding index for semantic retrieval. Segment sanitization and quality control may be applied, including removal of empty or low-information segments and selective reprocessing to improve retrieval quality.

The analysis module 222 may manage an IP Vault and enforce content release rules based on entitlement context and provenance metadata. Provenance metadata may represent source identity, owner identity, organizational boundary, trust tier, confidentiality classification, retention rules, and usage restrictions. In addition to raw excerpts, the system may release transformed representations such as redacted versions, anonymized versions, and summaries when full release is not authorized. Session policies may constrain persistence of confidential retrieval contexts and intermediate artifacts. The communication module 220 may apply session-level controls that constrain export, copying, or forwarding of protected content through external tools.

The analysis module 222 may organize accessible content using a Tree of Knowledge that defines tiers representing trust and sharing scope, including personal, instance, organizational, and community tiers. Promotion between tiers may be governed by policy rules and may require transformations prior to broader distribution. The analysis module 222 may implement response caching within the Tree of Knowledge, and reuse of cached artifacts may be conditioned on entitlement compatibility. The Tree of Knowledge may provide contextual organization and discoverability, while the IP Vault enforces fine-grained accessibility constraints.

For a user request, the communication module 220 may establish an interaction context and transmit the request and context to the analysis module 222. The analysis module 222 may perform query analysis and retrieve knowledge using multiple retrieval pathways, including vector-based retrieval, keyword or metadata retrieval, and graph-based retrieval. A knowledge graph may be constructed from ingested content and used as structured memory that supports cross-session continuity across multiple interaction surfaces.

Retrieval results may be filtered using IP Vault release rules and ranked using relevance and trust factors to construct a context package for a selected model. The analysis module 222 may generate an output using the selected model and transmit the output to the communication module 220 for presentation. Output controls may be applied to reduce unauthorized disclosure, including constraints on quotation and synthesis requirements.

The analysis module 222 may support operation with multiple models and select a model based on request characteristics and performance attributes. Model switching may be initiated by user input, administrator policy, or automated routing logic, and the analysis module 222 may apply the model training instructions and configuration data to preserve behavioral consistency across model changes. Different models may be used for different pipeline roles including query analysis, retrieval planning, summarization, response generation, safety review, and style alignment.

Agentic task execution may be supported. The communication module 220 may receive a task request and provide the request to the analysis module 222. The analysis module 222 may decompose a task into sub-tasks, retrieve authorized content, invoke tools when permitted, and generate intermediate and final outputs for delivery by the communication module 220. Autonomous task execution may be performed within boundaries defined by behavioral constraints and tool-use policies, and generated artifacts may be routed through an ingestion pipeline for indexing as accessible content.

Role-based entitlement controls may be applied. The communication module 220 may manage authentication state and obtain user attributes, subscription data, and temporal constraints, and the analysis module 222 may apply an entitlement framework that controls access to knowledge tiers, IP Vault release forms, tool invocation permissions, and model switching permissions. Tool integration may be supported through authenticated interfaces managed by the communication module 220 and structured tool requests generated by the analysis module 222.

Conversation continuity may be maintained by tracking token accumulation and generating a compact representation of earlier conversation content when a context threshold is approached. The compact representation may be stored in a persistent cache and reused in subsequent prompts. Streamed responses may be partitioned into a stable region and a modifiable region, and the stable region may be cached to reduce repeated parsing and rendering. Computational resources may be dynamically adjusted based on request complexity and latency objectives.

Voice interaction may be supported. The communication module 220 may receive audio input and deliver audio output according to one or more real-time speech interaction protocols, and the analysis module 222 may perform speech-to-text conversion, text-to-speech generation, and adaptation of generated text for speech delivery while maintaining retrieval grounding, policy enforcement, and psychometric alignment.

Interaction events may be routed through an event-driven communication bus. The communication module 220 may manage session handling and event routing, and the analysis module 222 may register handlers for retrieval, authorization, prompt construction, model selection, tool selection, and response generation, thereby allowing scaling of session handling independently from inference, retrieval, reranking, and ingestion workloads.

As an example, an organization may deploy the disclosed system to generate and operate an interactive digital representation of a university instructor for use in an academic environment. A communication module 220 may receive psychometric information associated with the instructor, including questionnaire responses, interview responses, course-related teaching preferences, communication-style indicators, and examples of prior instructional interactions. An analysis module 222 may process the psychometric information to generate model training instructions that define, for the interactive digital representation, a selected tone, explanation depth, teaching methodology, feedback style, and boundaries for permitted responses. The analysis module 222 may further train or configure one or more artificial intelligence models using the model training instructions so that outputs generated by the interactive digital representation reflect communication characteristics of the instructor.

The communication module 220 may obtain digital content representative of the instructor and associated academic materials from one or more institutional systems, including course syllabi, lecture transcripts, reading materials, assignment instructions, grading rubrics, frequently asked questions, historical announcements, and recorded question-and-answer sessions. The analysis module 222 may process the digital content into accessible content readable by the one or more artificial intelligence models, including segmenting documents, generating metadata, producing vector embeddings, and organizing the accessible content within a Tree of Knowledge under tiered access controls. Course-specific content may be stored in an instance-specific tier, department-level content may be stored in an organizational tier, and broadly reusable educational content may be stored in a broader tier subject to applicable access rules. Sensitive materials, including draft examinations, internal grading guidance, or restricted faculty notes, may be stored in an intellectual property vault under stricter access controls and released only when an entitlement context permits use of the materials.

A student may access the interactive digital representation through a course portal, a web-based chat interface, or a voice-enabled interface. The communication module 220 may authenticate the student and provide an entitlement context to the analysis module 222. When the student asks a question regarding a lecture topic, an assignment, or an exam concept, the analysis module 222 may determine characteristics of the request, retrieve authorized content from the Tree of Knowledge and, where permitted, from the intellectual property vault, and construct a context package for a selected artificial intelligence model. The selected artificial intelligence model may generate a response that is grounded in course materials and aligned with the instructor's communication style. The communication module 220 may then output the response to the student as text, synthesized speech, or both.

The system may further support agentic academic tasks. For example, a student may request generation of a study plan for an upcoming assessment, and the analysis module 222 may analyze prior interaction history, identify knowledge gaps, retrieve relevant course materials, and generate a study plan in a style consistent with the instructor. A teaching assistant or administrator may request that the interactive digital representation generate a draft review sheet, summarize common student misunderstandings, or draft responses to recurring course questions. In some cases, outputs generated through such interactions may be rendered into documents and re-ingested as searchable knowledge assets for later retrieval, subject to applicable approval rules and access controls.

The system may support continuity across repeated interactions over an academic term. The analysis module 222 may maintain conversation history for a given student and generate compacted summaries of earlier exchanges when token accumulation approaches a context threshold. The compacted summaries may be reused in subsequent prompts so that later interactions can reflect earlier explanations, known misconceptions, and previously discussed course topics without requiring full replay of the earlier interactions. In some implementations, the communication module 220 supports real-time voice interaction during virtual office hours, and the analysis module 222 adapts responses for speech delivery while preserving grounding and psychometric alignment.

This implementation enables the organization to provide a digital representation of the instructor that responds in a manner that is behaviorally aligned with the instructor, grounded in authorized course materials, and controlled according to institutional access policies. The same architecture may be adapted for other real-world deployments involving professionals, consultants, healthcare providers, or enterprise experts by substituting corresponding psychometric inputs, content repositories, entitlement rules, and task workflows.

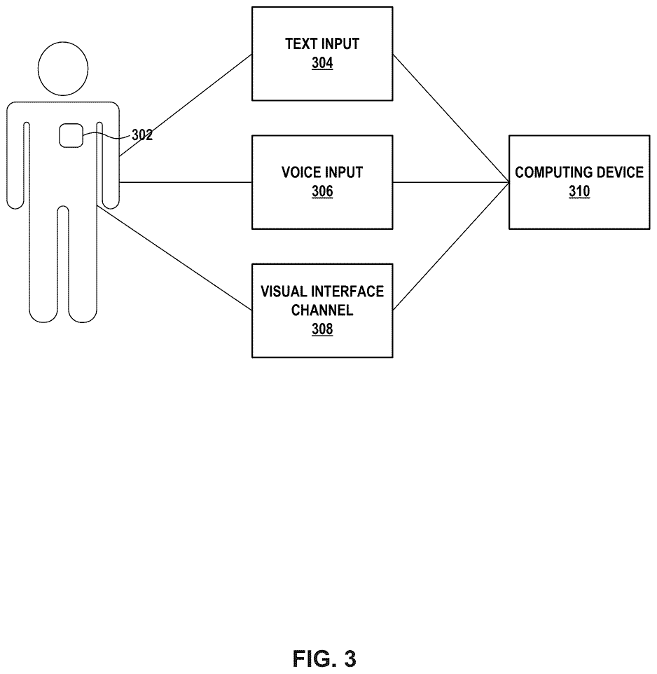

FIG. 3 is a diagram illustrating an example multi-modal interaction architecture through which the interactive digital representation communicates with users via text, voice, and visual interface channels. As shown in FIG. 3, the arrangement includes the user 302, a text input 304, a voice input 306, a visual interface channel 308, and the computing device 310. In accordance with the techniques described herein, the computing device 310 may implement one or more processors configured to process the indication of user input as a prompt for an interactive digital representation of an entity and to generate output in response to the prompt using a trained artificial intelligence model.

The text input 304, the voice input 306, and the visual interface channel 308 are each communicatively associated with the computing device 310. In the illustrated embodiment, each of the text input 304, the voice input 306, and the visual interface channel 308 is positioned between the user 302 and the computing device 310 such that the computing device 310 may receive user input through any one or more of the channels. For example, the text input 304 may correspond to a text-based prompt entered by the user 302, the voice input 306 may correspond to spoken input received from the user 302, and the visual interface channel 308 may correspond to a graphical or other visual interface through which the user 302 interacts with the computing device 310. Although illustrated as separate channels, in some examples, two or more of the text input 304, the voice input 306, and the visual interface channel 308 may be integrated within a common user interface.

The user 302 may selectively utilize the text input 304, the voice input 306, or the visual interface channel 308 to interact with the computing device 310 across a plurality of interaction surfaces. In some examples, the computing device 310 may receive an indication of user input comprising a prompt through the text input 304 and may generate responsive output for presentation through the visual interface channel 308. In some examples, the computing device 310 may receive the indication of user input through the voice input 306 and may generate output as an audio response through a conversational voice interface. In further examples, the visual interface channel 308 may present accessible content, generated output, or other information associated with the interactive digital representation while the text input 304 and/or the voice input 306 receives additional input from the user 302.

The computing device 310 may be configured to route information received through the text input 304, the voice input 306, and the visual interface channel 308 for processing by the one or more processors. In some examples, the one or more processors may determine one or more characteristics of content of the prompt received from the user 302 and generate output in response to the prompt using the trained artificial intelligence model. Where the interactive digital representation employs a conversational voice interface, the computing device 310 may provide an answer as displayed content through the visual interface channel 308 and may further provide an audio reading of the answer in a voice given to the interactive digital representation. Accordingly, FIG. 3 illustrates one example in which the computing device 310 supports multimodal interaction with the interactive digital representation of the entity.

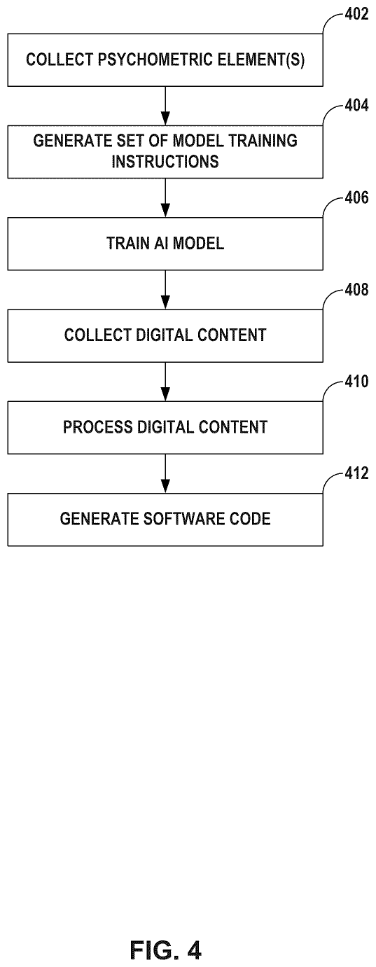

FIG. 4 is a flow chart illustrating an example mode of operation. The techniques of FIG. 4 may be performed by one or more processors of a computing device, such as computing device 110 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

In accordance with the techniques of this disclosure, communication module 220 collects one or more psychometric elements of an entity (402). Analysis module 222 generates a set of one or more model training instructions based at least in part on the one or more psychometric elements (404). Analysis module 222 trains an artificial intelligence model using the set of one or more model training instructions to form a trained artificial intelligence model (406). Communication module 220 collects digital content representative of the entity (408). Analysis module 222 processes the digital content to develop accessible content readable by the trained artificial intelligence model (410). Analysis module 222 generates software code that, when executed, initiates an interactive digital representation of the entity, wherein the interactive digital representation utilizes the trained artificial intelligence model and the accessible content (412).

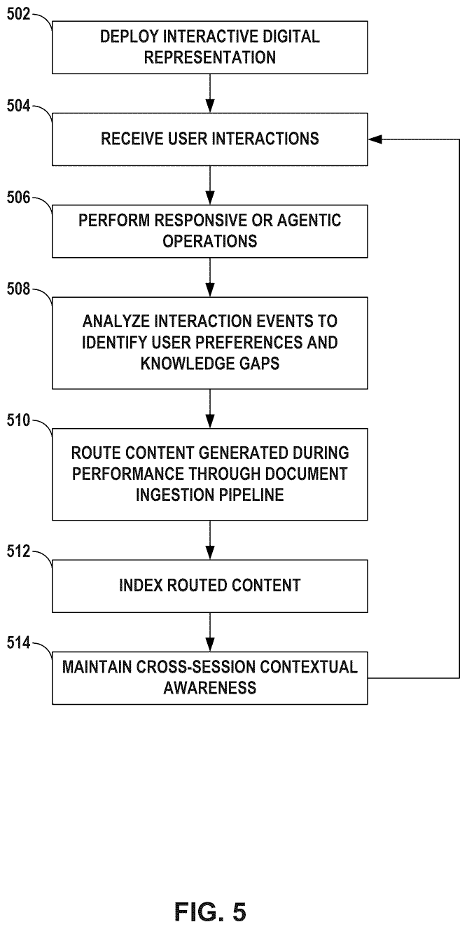

FIG. 5 is a flow diagram illustrating an example end-to-end process for creating, deploying, and operating an interactive digital representation using psychometric data and processed digital content representative of the entity. As shown in FIG. 5, the process includes deploying the interactive digital representation (502), receiving user interactions (504), performing responsive or agentic operations (506), analyzing interaction events to identify user preferences and knowledge gaps (508), routing generated content through a document ingestion pipeline (510), indexing the routed content (512), and maintaining cross-session contextual awareness (514).

At step 502, one or more processors deploy the interactive digital representation. In some examples, deploying the interactive digital representation includes initiating software code for the interactive digital representation such that the interactive digital representation utilizes a trained artificial intelligence model and accessible content associated with an entity. The interactive digital representation may be configured to simulate one or more psychometric characteristics of the entity, including communication style, expertise, and teaching methodology.

At step 504, the one or more processors receive user interactions. In some examples, receiving the user interactions includes receiving prompts, requests, commands, or other indications of user input directed to the interactive digital representation through one or more interaction surfaces, such as text interfaces, voice interfaces, or visual interfaces.

At step 506, the one or more processors perform responsive or agentic operations. In some examples, performing the responsive or agentic operations includes generating output responsive to the user interactions. In some further examples, performing the responsive or agentic operations includes performing an agentic task or a dynamic task using the interactive digital representation of the entity. The responsive or agentic operations may also include invoking one or more external applications or services through a tool integration framework, an application programming interface, or a protocol translation layer.

At step 508, the one or more processors analyze interaction events to identify user preferences and knowledge gaps. In some examples, analyzing the interaction events includes applying a pattern recognition algorithm to the user interactions and related interaction history to determine one or more user preferences, recurring interests, or knowledge gaps associated with a user. Information derived from the analysis may be used to adapt subsequent operation of the interactive digital representation while maintaining fidelity to one or more psychometric elements of the entity.

At step 510, the one or more processors route generated content through a document ingestion pipeline. In some examples, routing the generated content through the document ingestion pipeline includes routing content generated during performance of a task for later use as accessible content associated with the entity. The routed content may include content output by the interactive digital representation, content descriptive of the entity, or other content accumulated during operation of the system.

At step 512, the one or more processors index the routed content. In some examples, indexing the routed content includes processing the routed content into indexed content retrievable during later interactions. Indexing may include segmenting the routed content, generating metadata, and transforming at least portions of the routed content into vector embeddings or other searchable representations.

At step 514, the one or more processors maintain cross-session contextual awareness. In some examples, maintaining cross-session contextual awareness includes preserving context from prior interactions such that the interactive digital representation operates across a plurality of interaction surfaces while maintaining continuity across sessions. Maintaining cross-session contextual awareness may include maintaining a persistent cache for summaries or other compacted representations of earlier exchanges and inserting the compacted representations into subsequent prompts.

In some examples, the process may return from step 514 to step 504 such that later user interactions are processed in view of indexed content and preserved contextual awareness from one or more prior sessions. Although the steps of FIG. 5 are shown in one example order, the steps may be performed in different orders, and one or more steps may be omitted, repeated, or performed in parallel.

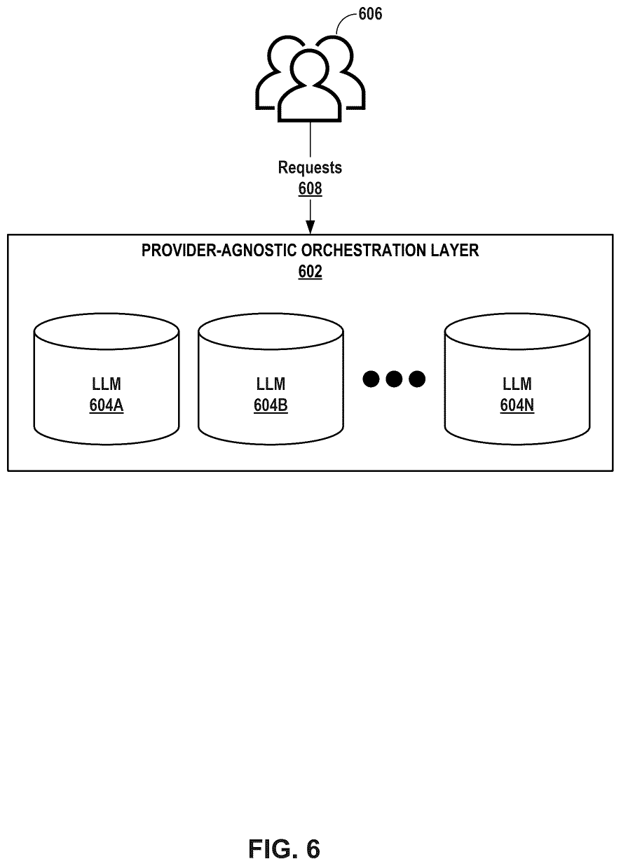

FIG. 6 is a block diagram illustrating an example provider-agnostic orchestration architecture for routing requests among multiple artificial intelligence model providers and model types. In the example of FIG. 6, one or more user(s) 606 provide requests 608 to provider-agnostic orchestration layer 602, and provider-agnostic orchestration layer 602 interfaces with the plurality of large language models 604A, 604B, 604N to generate output in response to the requests 608. Although three large language models are expressly shown, provider-agnostic orchestration layer 602 can interface with fewer or more large language models than illustrated.

Provider-agnostic orchestration layer 602 can be configured as a central orchestration component positioned logically between user(s) 606 and the plurality of large language models 604A, 604B, 604N. In some embodiments, provider-agnostic orchestration layer 602 receives a prompt included in a request 608 from a user 606, determines one or more characteristics of content of the prompt, and evaluates strengths of each of the plurality of large language models 604A, 604B, 604N relative to the prompt. Based at least in part on the one or more characteristics of content of the prompt and the strengths of each of the plurality of large language models 604A, 604B, 604N, provider-agnostic orchestration layer 602 can determine that one of the plurality of large language models 604A, 604B, 604N is well suited to provide accurate output in response to the prompt. Provider-agnostic orchestration layer 602 can thereby automatically switch from a first large language model to a second large language model for a digital representation and can cause the selected large language model to generate the output in response to the prompt.

In some embodiments, provider-agnostic orchestration layer 602 can implement provider-specific request formatting, response parsing, streaming protocol handling, and error handling while maintaining a common interface for requests 608 received from user(s) 606. In this way, provider-agnostic orchestration layer 602 can permit user(s) 606 and associated digital representations to access the plurality of large language models 604A, 604B, 604N in a manner that does not require redesign of upstream interaction flows when a different large language model is selected. In some examples, provider-agnostic orchestration layer 602 can further apply hierarchical credential resolution and institution-level configuration to select an available large language model and route the requests 608 accordingly.

The plurality of large language models 604A, 604B, 604N can represent different model families, different instances of a same model family, or models having different reasoning, latency, cost, safety, or domain-performance characteristics. Accordingly, FIG. 6 can represent a general architectural embodiment in which provider-agnostic orchestration layer 602 enables flexible model dispatch across multiple large language models while preserving continuity of the interaction experience for user(s) 606. In some embodiments, such orchestration can improve response quality for specialized prompts, reduce dependency on any single model implementation, and support future substitution, addition, or removal of large language models within the plurality of large language models 604A, 604B, 604N.

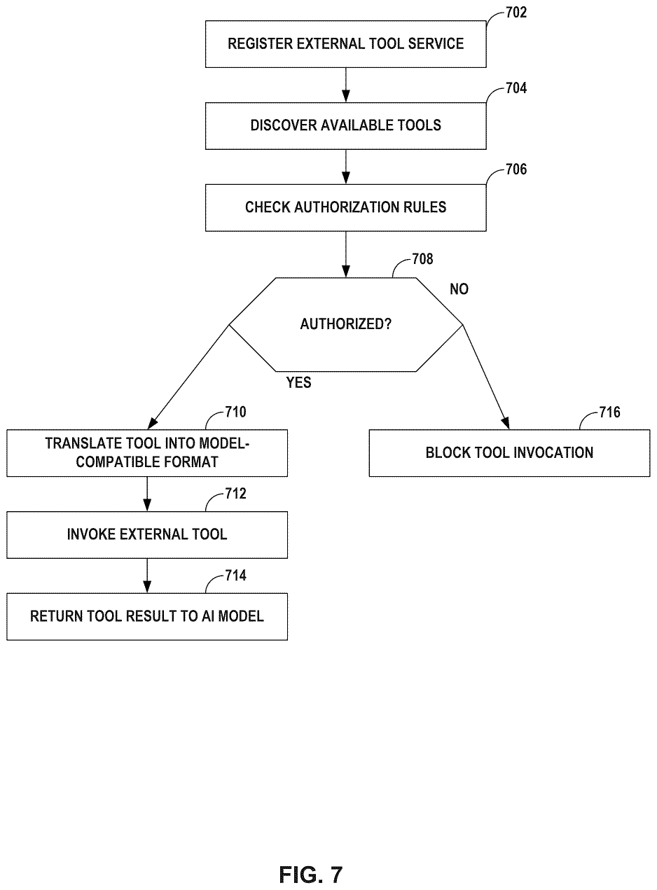

FIG. 7 is a flow diagram illustrating an example dynamic tool registration and invocation process for discovering, authorizing, translating, and invoking externally provided tools. The techniques of FIG. 7 may be performed by one or more processors of a computing device in communication with an artificial intelligence model. As shown in FIG. 7, the mode of operation includes registering an external tool service 702, discovering available tools 704, checking authorization rules 706, determining whether invocation is authorized at decision block 708, translating a tool into a model-compatible format 710, invoking an external tool 712, returning a tool result to the artificial intelligence model 714, and blocking tool invocation 716.

In accordance with the techniques described herein, the one or more processors may register the external tool service 702 so that the tool integration framework can recognize an external application programming interface, service endpoint, or other external application or service made available to the digital representation. After registration, the one or more processors may discover available tools 704 associated with the external tool service. In some examples, the discovered tools may define functions that are callable through the tool integration framework for performance of an agentic task. The one or more processors may then check authorization rules 706 associated with the requested tool invocation.

At decision block 708, the one or more processors determine whether the requested tool invocation is authorized. The authorization rules may be evaluated based on one or more access constraints associated with the tool integration framework. If the requested tool invocation is not authorized, the one or more processors may block tool invocation 716, thereby preventing the artificial intelligence model from interacting with the corresponding external application or service through that tool request.

If the requested tool invocation is authorized, the one or more processors may translate the tool into the model-compatible format 710. In some examples, translating the tool into the model-compatible format 710 includes applying a protocol translation layer so that a tool definition associated with the external tool service can be provided in a format usable by the artificial intelligence model. The one or more processors may then invoke the external tool 712 through the tool integration framework. After invocation, the one or more processors may return the tool result to the artificial intelligence model 714 so that the tool result can be used in generating output responsive to a prompt or other agentic task. In some examples, the tool invocation and return of the tool result may be coordinated through a central communication bus using an event-driven dispatch pattern.

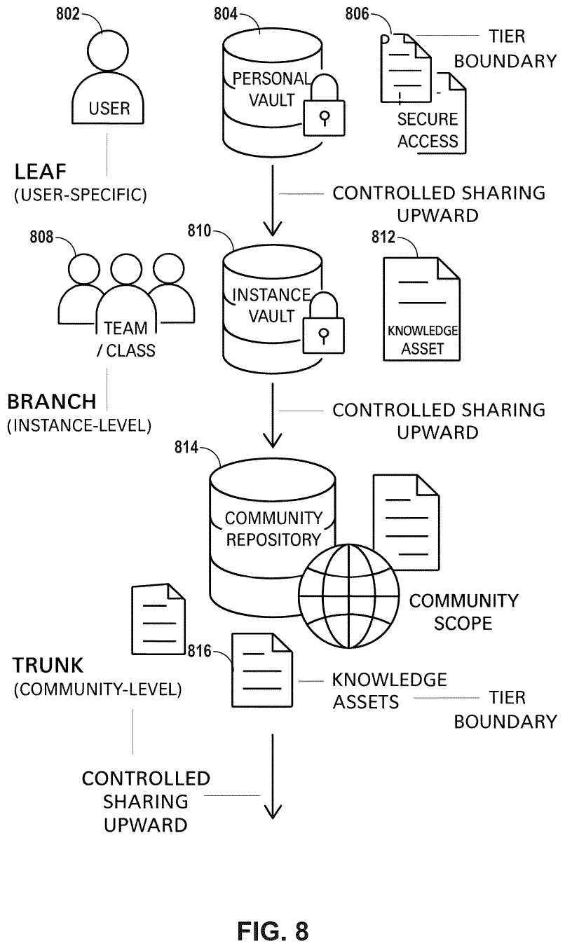

FIG. 8 is a diagram illustrating an example Tree of Knowledge architecture in which digital content is organized across multiple tiers associated with different trust levels and sharing scopes. In the example of FIG. 8, the hierarchical structure includes a user 802 associated with a personal vault 804 at a leaf tier, secure access 806 positioned at a tier boundary for the leaf tier, a team/class 808 associated with an instance vault 810 at a branch tier, a knowledge asset 812 associated with the branch tier, a community repository 814 at a trunk tier, and one or more knowledge assets 816 associated with a community-level scope. FIG. 8 illustrates an embodiment in which digital content may be shared upward in a controlled manner across the multiple tiers while maintaining access boundaries between the tiers.

In accordance with the techniques described herein, user 802 may create, upload, or otherwise maintain digital content within personal vault 804. Personal vault 804 may store user-specific knowledge assets accessible at a narrower access scope than higher tiers of the hierarchical structure. Secure access 806 may represent one or more security controls applied to content stored in personal vault 804, such as token-level encryption, access verification, provenance metadata enforcement, content anonymization, or other multi-level privacy controls. In some examples, secure access 806 enforces a tier boundary between the leaf tier and higher tiers so that digital content remains compartmentalized unless sharing is authorized.

Team/class 808 may represent a working group, class, cohort, department, or other instance-level set of users permitted to access content shared beyond the leaf tier. Instance vault 810 may store digital content that has been promoted or otherwise made available for controlled sharing within the instance level. Knowledge asset 812 may represent one or more documents, files, segments, or other digital content units stored in instance vault 810 and retrievable through the Tree of Knowledge architecture. In some examples, instance vault 810 enables the Tree of Knowledge architecture to control sharing of digital content across institutional boundaries and across interaction surfaces while preserving hierarchical trust levels and access restrictions. In some examples, content may move from personal vault 804 to instance vault 810 responsive to a user selection, an administrative control, a policy evaluation, or a sharing rule.

Community repository 814 may store digital content elevated beyond the instance level for broader access at the trunk tier. Knowledge assets 816 may represent community-level resources made available to a wider set of users than knowledge asset 812, while still remaining subject to applicable access controls and tier boundaries. In some examples, community repository 814 supports an intelligent response caching mechanism that automatically stores frequently accessed content and makes that content available at an appropriate trust level within the hierarchical structure. Although FIG. 8 shows upward controlled sharing from personal vault 804 to instance vault 810 and from instance vault 810 to community repository 814, the Tree of Knowledge architecture may include additional tiers, fewer tiers, or different promotion paths in other embodiments. In this way, the arrangement of FIG. 8 provides a hierarchical structure that organizes and prioritizes digital content based on levels of trust and access while enabling controlled sharing and retrieval of knowledge assets.

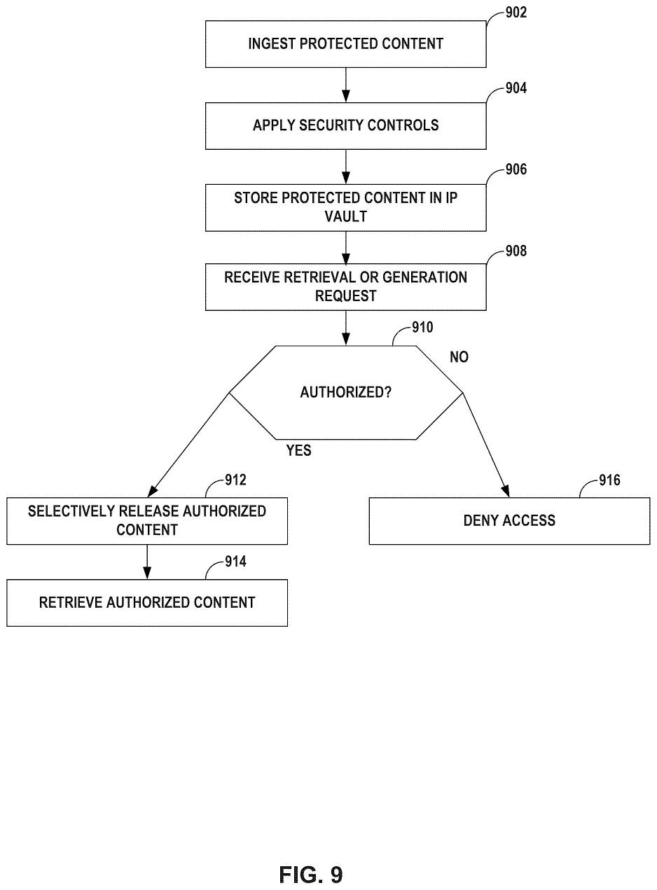

FIG. 9 is a flow diagram illustrating an example intellectual property vault pipeline for ingesting protected content, applying security controls, and selectively releasing authorized content for retrieval and generation. As shown in FIG. 9, the process includes ingesting protected content (902), normalizing and segmenting the protected content (904), associating provenance and policy metadata with the protected content (906), applying security controls to the protected content (908), generating retrieval-ready representations of the protected content (910), receiving a retrieval request associated with an entitlement context (912), evaluating authorization and selectively releasing content (914), and providing authorized content for retrieval and generation (916).

At step 902, one or more processors ingest protected content. In some examples, ingesting the protected content includes receiving digital content associated with an entity from one or more content sources, such as user uploads, administrator uploads, institutional repositories, communication systems, learning management systems, transcription pipelines, or synchronized enterprise sources. The protected content may include documents, transcripts, messages, audio content, video-derived text, structured datasets, or other digital materials representative of knowledge associated with the entity.

At step 904, the one or more processors normalize and segment the protected content. In some examples, normalizing and segmenting the protected content includes converting the protected content into one or more standardized machine-readable formats, extracting text and metadata, identifying content boundaries, and dividing the protected content into content units suitable for storage, indexing, retrieval, or controlled release. The one or more processors may further remove low-information artifacts, resolve formatting inconsistencies, and prepare the content units for downstream processing within the intellectual property vault pipeline.

At step 906, the one or more processors associate provenance and policy metadata with the protected content. In some examples, associating the provenance and policy metadata includes linking each content unit to source information, ownership information, an ingestion channel, an organizational boundary, a trust tier, a confidentiality classification, a retention rule, a permitted-use rule, or combinations thereof. The provenance and policy metadata may later be used to determine whether a particular content unit is eligible for retrieval, transformation, release, or inclusion in a context package for an interaction session.

At step 908, the one or more processors apply security controls to the protected content. In some examples, applying the security controls includes storing the protected content in compartmentalized storage, encrypting the protected content at rest or in transit, and enforcing fine-grained access controls at a document level, segment level, token level, or combinations thereof. Applying the security controls may further include assigning the protected content to one or more protected repositories, restricting cross-boundary access, and preserving source materials within the intellectual property vault unless and until release is authorized.

At step 910, the one or more processors generate retrieval-ready representations of the protected content. In some examples, generating the retrieval-ready representations includes generating vector embeddings, indices, summaries, redacted representations, anonymized representations, or other transformed representations of the content units for use in semantic retrieval or other search operations. The one or more processors may store the retrieval-ready representations separately from raw source content so that retrieval operations can be performed without indiscriminate exposure of protected materials.

At step 912, the one or more processors receive a retrieval request associated with an entitlement context. In some examples, receiving the retrieval request includes receiving a prompt, query, or task request from a user device or another system component and establishing an entitlement context for the request. The entitlement context may include one or more of a user identity, a user role, an organizational affiliation, a digital representation identifier, a session policy, a trust level, and one or more access constraints applicable to the request.

At step 914, the one or more processors evaluate authorization and selectively release content. In some examples, evaluating authorization and selectively releasing content includes determining, based at least in part on the entitlement context and the provenance and policy metadata, whether a content unit is authorized for release. When release is authorized, the one or more processors may release raw content, one or more excerpts, or one or more transformed representations of the content unit. When full release is not authorized, the one or more processors may release a redacted version, an anonymized version, a summary, metadata only, or may deny release altogether. In this way, the intellectual property vault may selectively control disclosure of protected content while still supporting retrieval and generation workflows.

At step 916, the one or more processors provide authorized content for retrieval and generation. In some examples, providing the authorized content includes supplying the authorized content to a retrieval pipeline, a context-construction process, or one or more artificial intelligence models for generation of output responsive to the retrieval request. The authorized content may be incorporated into a context package used to generate a response while remaining subject to output controls that limit unauthorized disclosure, including quotation restrictions, synthesis requirements, or overlap limits relative to protected source materials.

Although the steps of FIG. 9 are shown in one example order, the steps may be performed in different orders, one or more steps may be omitted, additional steps may be added, and one or more steps may be repeated or performed in parallel. Accordingly, FIG. 9 illustrates one example process by which an intellectual property vault pipeline may ingest protected content, apply security controls, and selectively release authorized content for retrieval and generation.

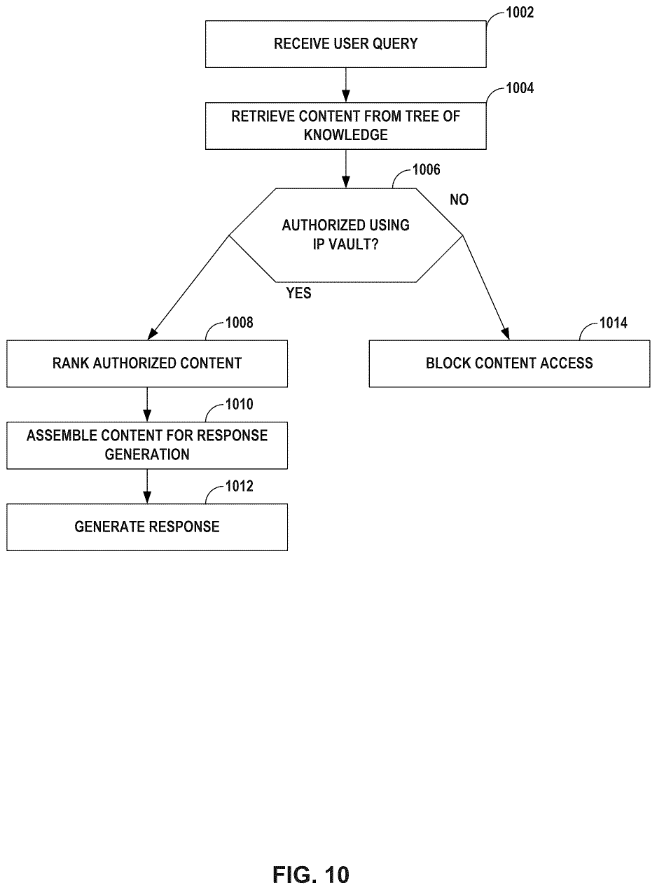

FIG. 10 is a flow diagram illustrating an example retrieval pipeline that uses the Tree of Knowledge and the intellectual property vault to identify, authorize, rank, and assemble content for response generation. As shown in FIG. 10, the process includes receiving a user query (1002), retrieving candidate content from a Tree of Knowledge architecture (1004), determining whether the candidate content is authorized using an intellectual property vault (1006), ranking authorized content (1008), assembling content for response generation (1010), generating a response (1012), and blocking content access (1014).

At step 1002, one or more processors receive a user query. In some examples, receiving the user query includes receiving a prompt, request, question, or task input from a user device for processing by an interactive digital representation of an entity.

At step 1004, the one or more processors retrieve candidate content from a Tree of Knowledge architecture. In some examples, retrieving the candidate content includes identifying digital content organized within a hierarchical knowledge structure having multiple tiers associated with different trust levels, access scopes, or sharing boundaries. The retrieved candidate content may include documents, segments, summaries, metadata, or other knowledge assets potentially relevant to the user query.

At step 1006, the one or more processors determine whether the candidate content is authorized using an intellectual property vault. In some examples, determining whether the candidate content is authorized includes evaluating one or more access controls associated with the candidate content based on an entitlement context, provenance metadata, confidentiality classification, trust tier, ownership information, or combinations thereof. Where particular candidate content does not satisfy one or more authorization requirements, the process may proceed to step 1014 for that candidate content.

At step 1008, the one or more processors rank authorized content. In some examples, ranking the authorized content includes prioritizing content that has satisfied authorization requirements based on relevance to the user query, trust level, freshness, authority, branch proximity within the Tree of Knowledge architecture, historical usefulness, or combinations thereof.

At step 1010, the one or more processors assemble content for response generation. In some examples, assembling the content for response generation includes selecting a set of authorized content items for inclusion in a context package used by one or more artificial intelligence models. The assembled content may include raw excerpts, transformed representations, summaries, metadata, or combinations thereof, depending on the release rules enforced by the intellectual property vault.

At step 1012, the one or more processors generate a response. In some examples, generating the response includes using the assembled content to produce output responsive to the user query while maintaining intellectual property boundaries and applying one or more output controls to reduce unauthorized disclosure of protected source materials.

At step 1014, the one or more processors block content access. In some examples, blocking content access includes preventing unauthorized candidate content from being released for response generation when the candidate content does not satisfy one or more authorization requirements evaluated at step 1006. In some further examples, blocking content access may include excluding the unauthorized candidate content from a context package, substituting a restricted indicator, or preventing disclosure of one or more protected portions of the candidate content.

Although the steps of FIG. 10 are shown in one example order, the steps may be performed in different orders, one or more steps may be omitted, additional steps may be added, and one or more steps may be repeated or performed in parallel. Accordingly, FIG. 10 illustrates one example process for retrieving candidate content from a Tree of Knowledge architecture, evaluating authorization using an intellectual property vault, and using authorized content for response generation.

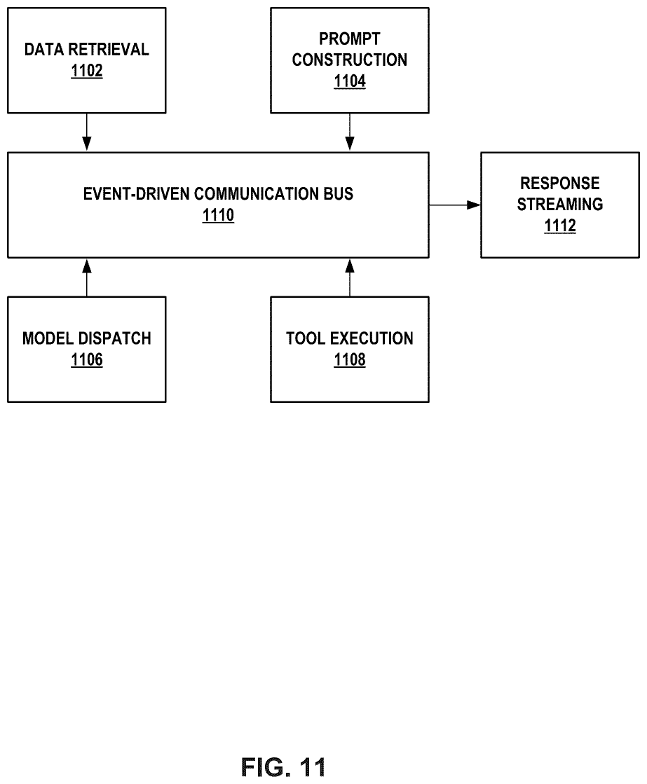

FIG. 11 is a block diagram illustrating an example event-driven communication bus architecture for coordinating session management, retrieval, prompt construction, model dispatch, tool execution, and response streaming. In the example of FIG. 11, the architecture includes a data retrieval 1102, a prompt construction 1104, a model dispatch 1106, a tool execution 1108, an event-driven communication bus 1110, and a response streaming 1112. FIG. 11 may represent a general implementation architecture for coordinating subsystems of an interactive digital representation, although other implementations may include additional components, fewer components, or different arrangements of the illustrated components.

As shown in FIG. 11, event-driven communication bus 1110 is centrally positioned relative to data retrieval 1102, prompt construction 1104, model dispatch 1106, and tool execution 1108. In some examples, event-driven communication bus 1110 receives interaction events from one or more upstream or parallel subsystems and distributes the interaction events to appropriate downstream processing paths. The event-driven communication bus 1110 may thereby operate as a central communication bus through which independent subsystems exchange event data without requiring fixed point-to-point coupling between all subsystems.

Data retrieval 1102 may perform knowledge retrieval responsive to an interaction event. For example, data retrieval 1102 may obtain accessible content, retrieved records, or other information responsive to a user input, session state, or task state and may provide retrieved information to event-driven communication bus 1110. In some examples, data retrieval 1102 may access a hierarchical knowledge structure, vector-based retrieval resources, cached content, or other stored information sources. Prompt construction 1104 may receive retrieved information, session context, prior exchanges, summaries, or other contextual inputs and may construct a prompt for use by one or more artificial intelligence models. In some examples, prompt construction 1104 may insert a compacted representation of earlier exchanges, preserve recent exchanges in full fidelity, or otherwise organize contextual material for subsequent model processing.

Model dispatch 1106 may coordinate AI model dispatch in response to events routed by event-driven communication bus 1110. For example, model dispatch 1106 may determine whether a first model, a second model, or another model of a plurality of models is to process a particular prompt, and may route the prompt accordingly. In some examples, model dispatch 1106 may support switching among models based at least in part on content characteristics, model strengths, latency conditions, availability, or other execution criteria. Because event-driven communication bus 1110 mediates communications among the subsystems, model dispatch 1106 may be scaled, replaced, or updated independently from data retrieval 1102 or prompt construction 1104.

Tool execution 1108 may coordinate tool invocation for performance of an agentic task or another operation associated with an interactive digital representation. In some examples, tool execution 1108 may interact with a tool integration framework that enables the digital representation to interact with external applications and services. Tool execution 1108 may receive invocation instructions through event-driven communication bus 1110, execute one or more tools locally or through a remote service, and return tool outputs, status events, or error events to event-driven communication bus 1110 for further handling by other subsystems.

Response streaming 1112 may receive output from event-driven communication bus 1110 and may provide streamed output for presentation at an interaction surface. In some examples, response streaming 1112 may stream generated textual output incrementally as output becomes available from one or more artificial intelligence models and tool results. Response streaming 1112 may accordingly permit progressive delivery of content while additional events continue to be processed by event-driven communication bus 1110. In this manner, the architecture of FIG. 11 may enable independent scaling of subsystems while maintaining coordinated handling of knowledge retrieval, prompt construction, AI model dispatch, tool invocation, and response streaming.

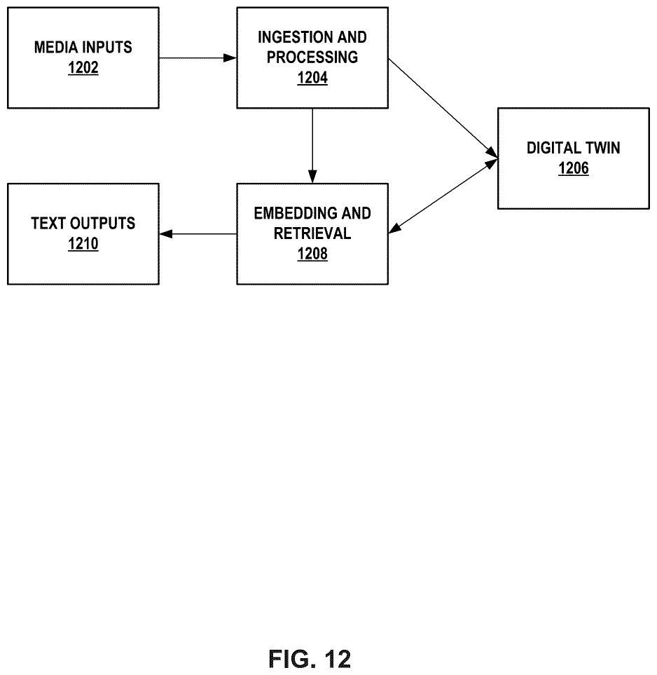

FIG. 12 is a diagram illustrating an example knowledge graph augmented retrieval architecture that combines semantic retrieval, graph-based retrieval, and ranking operations to provide structured memory for the interactive digital representation. In the example of FIG. 12, the data processing flow includes media inputs 1202, ingestion and processing 1204, digital twin 1206, embedding and retrieval 1208, and text outputs 1210. As shown, media inputs 1202 are provided to ingestion and processing 1204. Ingestion and processing 1204 provides processed content to embedding and retrieval 1208 and further provides content and/or control information to digital twin 1206. Embedding and retrieval 1208 provides retrieved content to digital twin 1206 and further provides output content for text outputs 1210. FIG. 12 accordingly illustrates an example embodiment in which digital content is ingested, transformed into accessible content, retrieved, and used by an interactive digital representation to support generation of output.

Media inputs 1202 can include digital content representative of an entity. For example, media inputs 1202 can include one or more of content authored by the entity, content descriptive of the entity, an interview with the entity, video content including the entity, text about the entity, images of the entity, audio spoken by the entity, and audio spoken about the entity. In some examples, media inputs 1202 can further include structured or unstructured source materials received from one or more local or remote repositories. In accordance with the techniques described herein, ingestion and processing 1204 can collect, normalize, parse, sanitize, segment, and otherwise process the digital content to develop accessible content readable by a trained artificial intelligence model. In some examples, ingestion and processing 1204 can perform format-specific extraction, chunking, metadata generation, and quality improvement of individual segments, including sanitization that preserves semantic value and removal of empty segments from the embedding space.

Embedding and retrieval 1208 can receive processed segments from ingestion and processing 1204 and can transform the processed segments into vector embeddings for storage and subsequent retrieval. In some examples, embedding and retrieval 1208 can further maintain a knowledge graph as persistent structured memory, can activate a plurality of independent retrieval pathways simultaneously, and can unify results through rank-based fusion and reranking. Accordingly, embedding and retrieval 1208 can retrieve accessible content responsive to a query, prompt, or interaction context associated with digital twin 1206. Although shown as a single block, embedding and retrieval 1208 can include one or more embedding models, vector indices, keyword indices, graph-based retrieval structures, scoring components, and context assembly components configured to identify content relevant to a current interaction.

Digital twin 1206 can include an interactive digital representation of the entity that utilizes a trained artificial intelligence model and the accessible content derived from media inputs 1202. In some examples, digital twin 1206 can receive retrieved accessible content from embedding and retrieval 1208 and can further receive processed content, instructions, metadata, or contextual information from ingestion and processing 1204. Based on these inputs, digital twin 1206 can generate responsive content that reflects one or more psychometric elements of the entity and domain knowledge represented by the accessible content. In some examples, digital twin 1206 can form part of a broader query processing pipeline in which retrieved content is assembled into a model context, combined with behavioral specification data and interaction history, and used to generate output for a user session.

Text outputs 1210 can include response text generated using the accessible content and the trained artificial intelligence model. In some examples, text outputs 1210 can include answers to user prompts, generated documents, summaries, instructional content, or other output content produced during interaction with digital twin 1206. As further shown in FIG. 12, the output path can proceed from embedding and retrieval 1208 to text outputs 1210, reflecting that retrieved and assembled content can be used to support generation, streaming, caching, or rendering of textual output. Although FIG. 12 illustrates text outputs 1210, in some examples the same underlying architecture can additionally support other interaction surfaces while preserving the ingestion, embedding, retrieval, and interactive digital representation relationships shown in the figure.

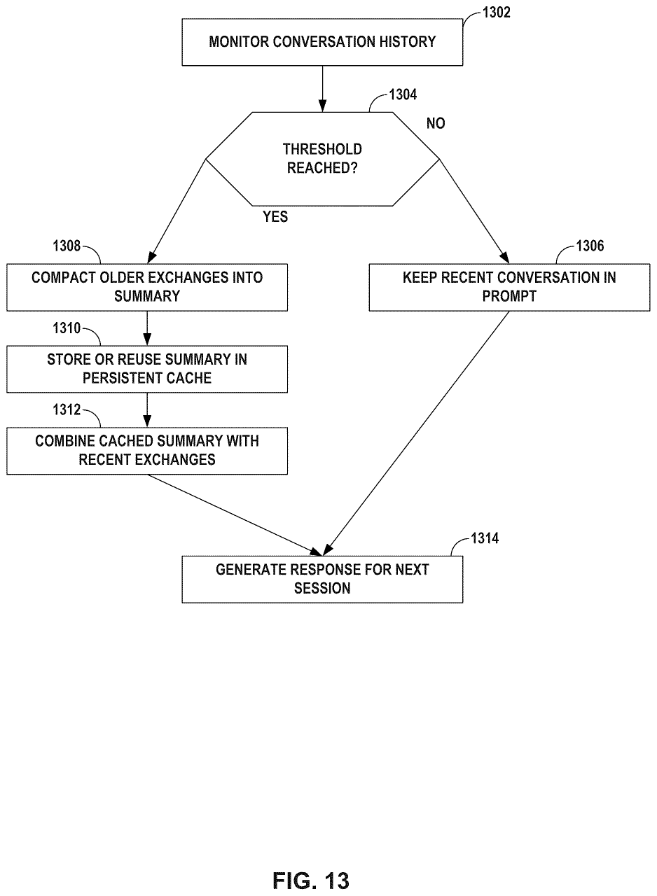

FIG. 13 is a flow diagram illustrating an example conversation history compaction and persistent caching process for preserving continuity across interaction sessions while reducing context usage. As shown in FIG. 13, the process includes monitoring conversation history (1302), determining whether a threshold is reached (1304), keeping recent conversation in a prompt (1306), compacting older exchanges into a summary (1308), storing or reusing the summary in a persistent cache (1310), combining the cached summary with recent exchanges (1312), and generating a response for a next session (1314).

At step 1302, one or more processors monitor conversation history. In some examples, monitoring the conversation history includes tracking accumulated exchanges within an interaction history and determining an amount of prompt space, token usage, or contextual information associated with the accumulated exchanges.

At step 1304, the one or more processors determine whether a threshold is reached. In some examples, determining whether the threshold is reached includes comparing the accumulated conversation history against a configurable threshold associated with prompt size, token count, memory allocation, or another context-management criterion. When the threshold is not reached, the process may proceed to step 1306. When the threshold is reached, the process may proceed to step 1308.

At step 1306, the one or more processors keep recent conversation in a prompt. In some examples, keeping the recent conversation in the prompt includes preserving one or more recent exchanges in full fidelity for inclusion in a subsequent prompt without summarizing older conversation content.

At step 1308, the one or more processors compact older exchanges into a summary. In some examples, compacting the older exchanges into the summary includes generating a compacted representation of earlier conversation history while preserving more recent exchanges separately. The summary may preserve contextual continuity from prior exchanges while reducing prompt length.

At step 1310, the one or more processors store or reuse the summary in a persistent cache. In some examples, storing or reusing the summary in the persistent cache includes saving the summary for later retrieval across multiple turns or sessions, or retrieving a previously generated summary for reuse in a later interaction.

At step 1312, the one or more processors combine the cached summary with recent exchanges. In some examples, combining the cached summary with the recent exchanges includes constructing a subsequent prompt that includes the summary of earlier conversation history together with one or more more recent exchanges maintained in higher fidelity.

At step 1314, the one or more processors generate a response for a next session. In some examples, generating the response for the next session includes using the prompt constructed from the recent exchanges alone or from the cached summary combined with the recent exchanges to generate output for a later interaction session.

Although the steps of FIG. 13 are shown in one example order, the steps may be performed in different orders, one or more steps may be omitted, additional steps may be added, and one or more steps may be repeated or performed in parallel. Accordingly, FIG. 13 illustrates one example process for selectively compacting conversation history and maintaining contextual continuity across sessions.

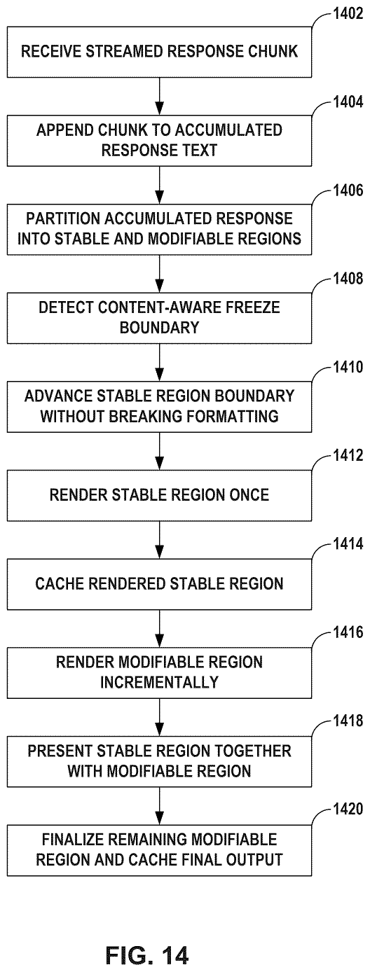

FIG. 14 is a flow diagram illustrating an example streamed response rendering process in which output is partitioned into stable and modifiable regions for incremental presentation and caching. As shown in FIG. 14, the process includes receiving a streamed response chunk (1402), appending the chunk to accumulated response text (1404), partitioning the accumulated response into stable and modifiable regions (1406), detecting a content-aware freeze boundary (1408), advancing a stable region boundary without breaking formatting (1410), rendering the stable region once (1412), caching the rendered stable region (1414), rendering the modifiable region incrementally (1416), presenting the stable region together with the modifiable region (1418), and finalizing the remaining modifiable region and caching the final output (1420).

At step 1402, one or more processors receive a streamed response chunk. In some examples, receiving the streamed response chunk includes receiving a portion of a response generated by an artificial intelligence model during a streaming output operation.

At step 1404, the one or more processors append the chunk to accumulated response text. In some examples, appending the chunk to the accumulated response text includes extending a current response buffer with the newly received portion of the streamed response.

At step 1406, the one or more processors partition the accumulated response into stable and modifiable regions. In some examples, partitioning the accumulated response includes identifying a stable region corresponding to finalized content and a modifiable region corresponding to content that remains subject to change as additional streamed response chunks are received.

At step 1408, the one or more processors detect a content-aware freeze boundary. In some examples, detecting the content-aware freeze boundary includes identifying a boundary between the stable region and the modifiable region based at least in part on formatting structure, syntactic completeness, semantic completeness, or combinations thereof.

At step 1410, the one or more processors advance a stable region boundary without breaking formatting. In some examples, advancing the stable region boundary includes moving the boundary forward when additional content has become sufficiently stable for final rendering while avoiding advancement into a portion of the accumulated response that would disrupt formatting integrity.

At step 1412, the one or more processors render the stable region once. In some examples, rendering the stable region once includes rendering content determined to be finalized without repeatedly re-rendering that content during subsequent streaming updates.

At step 1414, the one or more processors cache the rendered stable region. In some examples, caching the rendered stable region includes storing rendered output associated with the stable region for reuse during subsequent presentation updates.

At step 1416, the one or more processors render the modifiable region incrementally. In some examples, rendering the modifiable region incrementally includes repeatedly rendering a trailing portion of the response that remains subject to modification as additional streamed response chunks are received.

At step 1418, the one or more processors present the stable region together with the modifiable region. In some examples, presenting the stable region together with the modifiable region includes displaying finalized content and currently updating content concurrently within a user interface.

At step 1420, the one or more processors finalize the remaining modifiable region and cache the final output. In some examples, finalizing the remaining modifiable region and caching the final output includes determining that streaming has completed, rendering any remaining portion of the response as finalized content, and storing the completed rendered output.

Although the steps of FIG. 14 are shown in one example order, the steps may be performed in different orders, one or more steps may be omitted, additional steps may be added, and one or more steps may be repeated or performed in parallel. Accordingly, FIG. 14 illustrates one example process for incrementally rendering a streamed response while preserving formatting integrity and reducing redundant rendering operations.

The disclosed systems and methods provide a technical framework for generating and operating an interactive digital representation of an entity using psychometric elements, processed digital content, and one or more artificial intelligence models. By combining behavioral specification data with accessible content derived from source materials, the system can produce responses and perform tasks in a manner aligned with the entity's communication patterns, expertise, and contextual knowledge. The disclosed architecture may further support coordination among knowledge retrieval, model dispatch, response generation, and external tool invocation through a centralized orchestration framework, thereby enabling operation across multiple interaction surfaces and session contexts.

The disclosed systems and methods further provide technical effects associated with secure knowledge utilization and controlled information access. An intellectual property vault architecture may compartmentalize protected content, apply token-level verification, enforce provenance-aware access controls, support anonymization, and limit release of content to authorized forms for retrieval and generation. A Tree of Knowledge architecture may organize knowledge assets according to hierarchical trust levels and access scopes, thereby enabling controlled sharing across users, instances, institutions, or broader communities while preserving knowledge boundaries. Additional technical effects may include improved handling of large or evolving contexts through conversation-history compaction, persistent caching, structured retrieval, and incremental response rendering that reduces repeated processing while preserving formatting integrity.

These technical arrangements provide benefits over systems that rely on a single model, unstructured retrieval, or unrestricted exposure of source materials. The disclosed systems and methods may improve consistency of digital representation behavior, support use of proprietary or confidential content without unrestricted disclosure, improve relevance of retrieved information through prioritized and structured knowledge organization, and enable agentic task performance through controlled interaction with external applications and services. The disclosed techniques may also improve scalability and adaptability by supporting model switching, provider-agnostic integration, persistent memory across sessions, and modular subsystem coordination, while maintaining security, access control, and content-governance constraints.

Example 1. A method comprising: collecting, by one or more processors, one or more psychometric elements of an entity; generating, by the one or more processors, a set of one or more model training instructions based at least in part on the one or more psychometric elements; training, by the one or more processors, an artificial intelligence model using the set of one or more model training instructions to form a trained artificial intelligence model; collecting, by the one or more processors, digital content representative of the entity; processing, by the one or more processors, the digital content to develop accessible content readable by the trained artificial intelligence model; and generating, by the one or more processors, software code that, when executed, initiates an interactive digital representation of the entity, wherein the interactive digital representation utilizes the trained artificial intelligence model and the accessible content.

Example 2. The method of Example 1, wherein the one or more psychometric elements comprise one or more of: personality traits, communication style, instructional or advisory methodologies, answers to a personality questionnaire, results of a personality test, behavioral assessments, expert interviews, content analysis, and experience of the entity.

Example 3. The method of any one or more of Examples 1-2, wherein the processing of the digital content comprises: accessing, by the one or more processors, elements from an IP Vault for secure knowledge compartmentalization; implementing, by the one or more processors, added security measures through token-level encryption; and utilizing, by the one or more processors, a Tree of Knowledge architecture to organize and prioritize information based on hierarchical trust levels.

Example 4. The method of Example 3, further comprising: transforming, by the one or more processors, the digital content into vector embeddings from which original content cannot be reconstructed; verifying, by the one or more processors, access at the token level using provenance metadata; applying, by the one or more processors, content anonymization for broader access tiers; enforcing, by the one or more processors, compartmentalized knowledge boundaries for representations of real individuals; and supporting, by the one or more processors, ephemeral knowledge sessions for confidential materials.

Example 5. The method of any one or more of Examples 3-4, wherein the Tree of Knowledge architecture organizes digital content into a hierarchical structure comprising multiple tiers, each tier representing different levels of trust and access.

Example 6. The method of any one or more of Examples 3-5, further comprising utilizing the Tree of Knowledge architecture to control sharing of digital content across institutional boundaries.

Example 7. The method of any one or more of Examples 3-6, wherein the Tree of Knowledge architecture includes an intelligent response caching mechanism that automatically stores frequently accessed content.

Example 8. The method of any one or more of Examples 3-7, wherein the Tree of Knowledge architecture integrates with the IP Vault to provide multi-level privacy controls.

Example 9. The method of any one or more of Examples 3-8, wherein the Tree of Knowledge architecture employs hierarchical vector embedding techniques that associate structural metadata, trust-tier indicators, and branch-level context with content high-dimensional representations to enable tier-aware semantic retrieval across the hierarchical structure.

Example 10. The method of any one or more of Examples 1-9, further comprising: constructing, by the one or more processors, a knowledge graph from digital content using extraction models operating exclusively on source material text spans; activating, by the one or more processors, a plurality of independent retrieval pathways simultaneously; unifying, by the one or more processors, results through rank-based fusion, reranking fused results using a learned relevance model; and maintaining, by the one or more processors, the knowledge graph as persistent structured memory across interaction surfaces.

Example 11. The method of any one or more of Examples 1-10, further comprising: submitting, by the one or more processors, vector embedding segments to a vector model for quality improvement after document ingestion; sanitizing, by the one or more processors, segment content while preserving semantic value; and detecting and removing, by the one or more processors, empty segments from the embedding space.

Example 12. The method of any one or more of Examples 1-11, further comprising: monitoring, by the one or more processors, conversation token accumulation against a configurable threshold; generating, by the one or more processors, a summary of earlier exchanges while preserving recent exchanges in full fidelity; maintaining, by the one or more processors, a persistent cache for the summary; and inserting, by the one or more processors, the compacted representation into subsequent prompts to enable multi-session coherence exceeding individual model context window limitations.

Example 13. The method of any one or more of Examples 1-12, wherein the set of one or more model training instructions are structured as a multi-section behavioral specification document defining one or more of mission and values, helpfulness standards, role hierarchy, transparency requirements, and safety boundaries, combined with institution-level and user-level contextual data to govern behavior of the interactive digital representation.

Example 14. The method of any one or more of Examples 1-13, wherein the artificial intelligence model comprises a first large language model of a plurality of large language models, and wherein the method further comprises: receiving, by the one or more processors, an indication of user input to switch from the first large language model to a second large language model of the plurality of large language models; and automatically training, by the one or more processors, the second large language model using the set of one or more model training instructions and any additional information entered for the first large language model to form a second trained artificial intelligence model.

Example 15. The method of any one or more of Examples 1-14, wherein the artificial intelligence model comprises a first large language model of a plurality of large language models, and wherein the method further comprises: receiving, by the one or more processors, an indication of user input comprising a prompt for the trained artificial intelligence model; determining, by the one or more processors, one or more characteristics of content of the prompt; determining, by the one or more processors, and based at least in part on the one or more characteristics of the content of the prompt and strengths of each of the plurality of large language models, that a second large language model of the plurality of large language models is best capable of providing accurate output in response to the prompt; automatically switching, by the one or more processors, from the first large language model to the second large language model for the digital representation; and generating, by the one or more processors, output in response to the prompt using the second large language model.

Example 16. The method of any one or more of Examples 1-15, further comprising: receiving, by the one or more processors, an indication of user input for performing an agentic task; using, by the one or more processors, the digital representation of the entity to perform the agentic task and generate output as a result of the performing the agentic task; and outputting, by the one or more processors and to an output device, the generated output.

Example 17. The method of Example 16, wherein the agentic task comprises one or more of: a healthcare task, a legal task, a personal productivity task, an education task, an entertainment task, and a dynamic task.

Example 18. The method of Example 17, wherein the dynamic task comprises an autonomous task performed by the interactive digital representation without real-time human supervision within boundaries defined by a behavioral specification document, wherein the method further comprises: routing, by the one or more processors, content generated during performance of the dynamic task through a document ingestion pipeline for indexing within accessible content for the entity to create a closed-loop knowledge lifecycle; continuously adapting, by the one or more processors, task performance strategy based on accumulated interaction history while maintaining fidelity to the one or more psychometric elements of the entity; and operating, by the one or more processors, across a plurality of interaction surfaces maintaining cross-session contextual awareness.

Example 19. The method of any one or more of Examples 1-18, further comprising: applying, by the one or more processors, a role-based entitlement framework to manage access to resources and functionalities based on one or more of user attributes, subscription data, and temporal constraints.

Example 20. The method of any one or more of Examples 1-19, further comprising: utilizing, by the one or more processors, a tool integration framework to enable the digital representation to interact with external applications and services.

Example 21. The method of any one or more of Examples 1-20, further comprising: applying, by the one or more processors, a pattern recognition algorithm to analyze user interactions to identify user preferences and knowledge gaps.

Example 22. The method of any one or more of Examples 1-21, further comprising: dynamically allocating, by the one or more processors, computational resources by selecting among available models, adjusting processing depth, and distributing tasks across processing nodes based on the complexity of the digital content and latency objectives.

Example 23. The method of any one or more of Examples 1-22, further comprising: partitioning, by the one or more processors, a streamed AI response into a frozen region of finalized content and a live region subject to modification; advancing, by the one or more processors, the boundary using content-aware detection that preserves structured formatting integrity; and caching, by the one or more processors, the frozen content.

Example 24. The method of any one or more of Examples 1-23, wherein the digital content comprises any one or more of: content authored by the entity, content output of the interactive digital representation of the entity, content descriptive of the entity, an interview with the entity, video content including the entity, text about the entity, images of the entity, audio spoken by the entity, audio spoken about the entity, and any other content from which relevant information can be extracted that enhances the interactive digital representation's ability to simulate the entity's communication style and expertise.

Example 25. The method of any one or more of Examples 1-24, further comprising integrating the interactive digital representation with a third-party system through one or more of an application programming interface and a protocol translation layer.

Example 26. The method of any one or more of Examples 1-25, wherein the digital representation employs a conversational voice interface supporting a plurality of real-time speech interaction protocols.

Example 27. The method of any one or more of Examples 1-26, further comprising: routing, by the one or more processors, interaction events through a central communication bus coordinating AI model dispatch, knowledge retrieval, tool invocation, and response streaming through an event-driven dispatch pattern enabling independent scaling of subsystems.

Example 28. A device configured to perform any of the methods of any combination of Examples 1-27.

Example 29. An apparatus comprising means for performing any of the method of any combination of Examples 1-27.

Example 30. A non-transitory computer-readable storage medium having stored thereon instructions that, when executed, cause one or more processors of a computing device to perform the method of any combination of Examples 1-27.

Example 31. A system comprising one or more computing devices configured to perform a method of any combination of Examples 1-27.

Example 32. A method for performing any of the techniques of any combination of Examples 1-27.

Example 33. Any of the techniques described herein.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wavelength, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
collecting, by one or more processors, one or more psychometric elements of an entity;
generating, by the one or more processors, a set of one or more model training instructions based at least in part on the one or more psychometric elements;
training, by the one or more processors, an artificial intelligence model using the set of one or more model training instructions to form a trained artificial intelligence model;
collecting, by the one or more processors, digital content representative of the entity;
processing, by the one or more processors, the digital content to develop accessible content readable by the trained artificial intelligence model; and
generating, by the one or more processors, software code that, when executed, initiates an interactive digital representation of the entity, wherein the interactive digital representation utilizes the trained artificial intelligence model and the accessible content.

2. The method of claim 1, wherein the one or more psychometric elements comprise one or more of:
personality traits,
communication style,
instructional or advisory methodologies,
answers to a personality questionnaire,
results of a personality test,
behavioral assessments,
expert interviews,
content analysis, and
experience of the entity.

3. The method of claim 1, wherein the processing of the digital content comprises:
accessing, by the one or more processors, elements from an IP Vault for secure knowledge compartmentalization;
implementing, by the one or more processors, added security measures through token-level access verification; and
utilizing, by the one or more processors, a Tree of Knowledge architecture to organize and prioritize information based on hierarchical trust levels.

4. The method of claim 3, further comprising:
transforming, by the one or more processors, the digital content into vector embeddings from which original content cannot be reconstructed;
verifying, by the one or more processors, access at the token level using provenance metadata;
applying, by the one or more processors, content anonymization for broader access tiers;
enforcing, by the one or more processors, compartmentalized knowledge boundaries for representations of real individuals; and
supporting, by the one or more processors, ephemeral knowledge sessions for confidential materials.

5. The method of claim 3, wherein the Tree of Knowledge architecture organizes digital content into a hierarchical structure comprising multiple tiers, each tier representing different levels of trust and access.

6. The method of claim 3, further comprising utilizing the Tree of Knowledge architecture to control sharing of digital content across institutional boundaries.

7. The method of claim 3, wherein the Tree of Knowledge architecture includes an intelligent response caching mechanism that automatically stores frequently accessed content.

8. The method of claim 3, wherein the Tree of Knowledge architecture integrates with the IP Vault to provide multi-level privacy controls.

9. The method of claim 3, wherein the Tree of Knowledge architecture employs hierarchical vector embedding techniques that associate structural metadata, trust-tier indicators, and branch-level context with content high-dimensional representations.

10. The method of claim 1, further comprising:
constructing, by the one or more processors, a knowledge graph from digital content using extraction models operating exclusively on source material text spans;
activating, by the one or more processors, a plurality of independent retrieval pathways simultaneously;
unifying, by the one or more processors, results through rank-based fusion, reranking fused results using a learned relevance model; and
maintaining, by the one or more processors, the knowledge graph as persistent structured memory across interaction surfaces.

11. The method of claim 1, further comprising:
submitting, by the one or more processors, vector embedding segments to a vector model for quality improvement after document ingestion;
sanitizing, by the one or more processors, segment content while preserving semantic value; and
detecting and removing, by the one or more processors, empty segments from the embedding space.

12. The method of claim 1, further comprising:
monitoring, by the one or more processors, conversation token accumulation against a configurable threshold;
generating, by the one or more processors, a summary of earlier exchanges while preserving recent exchanges in full fidelity;
maintaining, by the one or more processors, a persistent cache for the summary; and
inserting, by the one or more processors, the compacted representation into subsequent prompts to enable multi-session coherence exceeding individual model context window limitations.

13. The method of claim 1, wherein the set of one or more model training instructions are structured as a multi-section behavioral specification document defining one or more of mission and values, helpfulness standards, role hierarchy, transparency requirements, and safety boundaries, combined with institution-level and user-level contextual data to govern behavior of the interactive digital representation.

14. The method of claim 1, wherein the artificial intelligence model comprises a first large language model of a plurality of large language models, and wherein the method further comprises:
receiving, by the one or more processors, an indication of user input to switch from the first large language model to a second large language model of the plurality of large language models; and
automatically training, by the one or more processors, the second large language model using the set of one or more model training instructions and any additional information entered for the first large language model to form a second trained artificial intelligence model.

15. The method of claim 1, wherein the artificial intelligence model comprises a first large language model of a plurality of large language models, and wherein the method further comprises:
receiving, by the one or more processors, an indication of user input comprising a prompt for the trained artificial intelligence model;
determining, by the one or more processors, one or more characteristics of content of the prompt;
determining, by the one or more processors, and based at least in part on the one or more characteristics of the content of the prompt and strengths of each of the plurality of large language models, that a second large language model of the plurality of large language models is best capable of providing accurate output in response to the prompt;
automatically switching, by the one or more processors, from the first large language model to the second large language model for the digital representation; and
generating, by the one or more processors, output in response to the prompt using the second large language model.

16. The method of claim 1, further comprising:
receiving, by the one or more processors, an indication of user input for performing an agentic task;
using, by the one or more processors, the digital representation of the entity to perform the agentic task and generate output as a result of the performing the agentic task; and
outputting, by the one or more processors and to an output device, the generated output.

17. The method of claim 16, wherein the agentic task comprises one or more of:
a healthcare task,
a legal task,
a personal productivity task,
an education task,
an entertainment task, and
a dynamic task.

18. The method of claim 17, wherein the dynamic task comprises an autonomous task performed by the interactive digital representation without real-time human supervision within boundaries defined by a behavioral specification document, wherein the method further comprises:
routing, by the one or more processors, content generated during performance of the dynamic task through a document ingestion pipeline for indexing within accessible content for the entity to create a closed-loop knowledge lifecycle;
continuously adapting, by the one or more processors, task performance strategy based on accumulated interaction history while maintaining fidelity to the one or more psychometric elements of the entity; and
operating, by the one or more processors, across a plurality of interaction surfaces maintaining cross-session contextual awareness.

19. The method of claim 1, further comprising:
applying, by the one or more processors, a role-based entitlement framework to manage access to resources and functionalities based on one or more of user attributes, subscription data, and temporal constraints.

20. The method of claim 1, further comprising:
utilizing, by the one or more processors, a tool integration framework to enable the digital representation to interact with external applications and services.

21. The method of claim 1, further comprising:
applying, by the one or more processors, a pattern recognition algorithm to analyze user interactions to identify user preferences and knowledge gaps.

22. The method of claim 1, further comprising:
dynamically allocating, by the one or more processors, computational resources by selecting among available models, adjusting processing depth, and distributing tasks across processing nodes based on the complexity of the digital content and latency objectives.

23. The method of claim 1, further comprising:
partitioning, by the one or more processors, a streamed AI response into a frozen region of finalized content and a live region subject to modification;
advancing, by the one or more processors, the boundary using content-aware detection that preserves structured formatting integrity; and
caching, by the one or more processors, the frozen content.

24. The method of claim 1, wherein the digital content comprises any one or more of:
content authored by the entity,
content output of the interactive digital representation of the entity,
content descriptive of the entity,
an interview with the entity,
video content including the entity,
text about the entity,
images of the entity,
audio spoken by the entity,
audio spoken about the entity, and
any other content from which relevant information can be extracted that enhances the interactive digital representation's ability to simulate the entity's communication style and expertise.

25. The method of claim 1, further comprising integrating the interactive digital representation with a third-party system through one or more of an application programming interface and a protocol translation layer.

26. The method of claim 1, wherein the digital representation employs a conversational voice interface supporting a plurality of real-time speech interaction protocols.

27. The method of claim 1, further comprising:
routing, by the one or more processors, interaction events through a central communication bus coordinating AI model dispatch, knowledge retrieval, tool invocation, and response streaming through an event-driven dispatch pattern enabling independent scaling of subsystems.
